(19) United States
(12) Patent Application Publication
(10) Pub. No.: US 2016/0203700 A1
(43) Pub. Date: Jul. 14, 2016

(54) METHODS AND SYSTEMS TO MAKE CHANGES IN HOME AUTOMATION BASED ON USER STATES

(71) Applicant: Echostar Technologies L.L.C., Englewood, CO (US)

(72) Inventors: Christopher William Bruhn, Aurora, CO (US); Phuc H. Nguyen, Parker, CO (US)

(21) Appl. No.: 15/075,412

(22) Filed: Mar. 21, 2016

Related U.S. Application Data
(63) Continuation-in-part of application No. 14/229,684, filed on Mar. 28, 2014.

(51) Int. Cl. G08B 25/00; H04L 12/28

(52) U.S. Cl. CPC G08B 25/008; H04L 12/2803

(57) ABSTRACT

The present disclosure relates to determining when a user has fallen asleep and adjusting electronics based on that determination. Example methods and systems of the disclosure include receiving, at a sensor of a home automation system, characteristic data, wherein the characteristic data indicates one or more observed characteristics of a user of a home security system, wherein the home security system is connected to the home automation system, analyzing the characteristic data to determine a state of the user, determining, using the characteristic data, that the user has fallen asleep, and transmitting a communication to the home security system, wherein the communication includes a command to activate the home security system.

### CROSS-REFERENCE TO RELATED APPLICATIONS

This application is a continuation-in-part of U.S. application Ser. No. 14/229,684, filed Mar. 28, 2014, the disclosure of which is incorporated by reference herein in its entirety.

### TECHNICAL FIELD

The present disclosure relates to conserving energy use by electronics. The present disclosure relates, more particularly, to determining when a user has fallen asleep and adjusting electronics based on that determination.

### BACKGROUND

Electronics generally require power to function. Some electronics require battery power, and other electronics require power from other sources. In either situation, power may be drained unnecessarily if the electronics are left “on” or running for an extended period of time, especially when the electronics are not being used while they are running. For example, if electornics are being used, but a user of the electronics falls asleep, the electronics may continue to run even after the user has fallen asleep. While the user is asleep, the battery of the electronics may drain, or electricity may be used unnecessarily. For example, the user's electricity bill may be higher than necessary since electricity is being used on the electronics while the user is sleeping. In a more specific example, a television left on while a user is sleeping may use electricity from a structure's power source while a user is sleeping, even though the user is not gaining a benefit from the television being left on. In another example, a wireless headset or other wearable device may use unnecessary battery power while a user wearing the headset is sleeping.

Media programs such as television programming, movies, video games, etc. typically include a video portion and an audio portion. The video portion of the media programs is commonly displayed on a television or computer monitor. The audio portion of the media programs is commonly output from speakers connected to the television or monitor, or from a home entertainment sound system including a large arrangement of speakers. However, it has become increasingly common for users to receive the audio portion of a media program through the headphones of a wireless headset. The wireless headset receives the audio portion of the media program wirelessly from a television receiver, a game console, a DVD player, stereo system, etc. The wireless headset reproduces the audio portion for the user via the earphones of the wireless headset. Wireless headsets are typically powered by a battery or batteries. A comparatively large amount of power is consumed by the wireless headset when the wireless transceiver, which receives the audio portion of the media program, is active. There are many instances in which the wireless transceiver of the wireless headset continues to function when the user is no longer listening. This consumes battery power and causes the user to need to replace or recharge batteries more frequently than desired.

### SUMMARY

Embodiments of the present technology are directed to a computer-implemented method. The method may include receiving, at a sensor of a home automation system, characteristic data, wherein the characteristic data indicates one or more observed characteristics of a user of a home security system, wherein the home security system is connected to the home automation system; analyzing the characteristic data to determine a state of the user; determining, using the characteristic data, that the user has fallen asleep; and transmitting a communication to the home security system, wherein the communication includes a command to activate the home security system.

In alternative aspects, determining that the user has fallen asleep includes comparing the characteristic data to previous characteristic data, wherein the previous characteristic data indicates that the user had not fallen asleep. In alternative aspects the one or more of the observed characteristics include a physical position of the user. In alternative aspects, determining that the user has fallen asleep is based on movements of the user's head detected by the sensor. In alternative aspects, the sensor is included in a remote control of a television distribution system connected to the home automation system. In alternative aspects, the method may further comprise receiving home automation data, wherein the home automation data includes data collected over time by the home automation system, and wherein the home automation data is indicative of actions observed in an environment of the home automation system; and transmitting the communication to the home security system based on the home automation data. In alternative aspects determining that the user has fallen asleep is based on detecting that a portion of the user has remained at a particular orientation for a period of time longer than a threshold time. In alternative aspects, the orientation indicates that the user's head is not upright. In alternative aspects, the method may further comprise receiving updated characteristic data, wherein the updated characteristic data indicates one or more observed characteristics of a user of a home security system; analyzing the updated characteristic data to determine an updated state of the user; determining, using the updated characteristic data, that the user has woken up; and transmitting a new communication to the home security system, wherein the communication includes a command to deactivate the home security system.

Alternative embodiments of the present technology are directed to a home automation system. The home automation system may include a home automation device including a sensor, the sensor configured to receive characteristic data, wherein the characteristic data indicates one or more observed characteristics of a user of a home security system, wherein the home security system is connected to the home automation system; a controller connected to the home automation device, the controller configured to analyze the characteristic data to determine that the user has fallen asleep, and configured to transmit a communication indicating that the home security system should be turned on; and a home security device connected to the home automation device and the controller, the home security device configured to receive the communication and, upon receiving the communication, turn on the home security system.

In alternative aspects, determining that the user has fallen asleep includes comparing the characteristic data to previous characteristic data, wherein the previous characteristic data indicates that the user had not fallen asleep. In alternative aspects the one or more of the observed characteristics include a physical position of the user. In alternative aspects, determining that the user has fallen asleep is based on movements of the user's head detected by the sensor. In alternative aspects, the controller is further configured to receive home automation data, wherein the home automation data includes data collected over time by the home automation device, and the home automation data is indicative of actions observed in an environment of the home automation device, and transmit a communication to the home security device based on the home automation data. In alternative aspects determining that the user has fallen asleep is based on detecting that a portion of the user has remained at a particular orientation for a period of time longer than a threshold time. In alternative aspects, the orientation indicates that the user's head is not upright. In alternative aspects, the sensor is further configured to receive updated characteristic data, wherein the updated characteristic data indicates one or more observed characteristics of a user of a home security system; and the controller is further configured to analyze the updated characteristic data to determine an updated state of the user, determine, using the updated characteristic data, that the user has woken up, and transmit a new communication to the home security system, wherein the communication includes a command to deactivate the home security system.

Alternative embodiments of the present technology are directed to a television receiver, comprising one or more processors, a wireless transceiver communicatively coupled to the one or more processors, and a non-transitory computer readable storage medium communicatively coupled to the one or more processors, wherein the non-transitory computer readable storage medium includes instructions that, when executed by the one or more processors, cause the one or more processors to perform operations. The operations may include receiving, at a sensor of a home automation system, characteristic data, wherein the characteristic data indicates one or more observed characteristics of a user of a home security system, wherein the home security system is connected to the home automation system; analyzing the characteristic data to determine a state of the user; determining, using the characteristic data, that the user has fallen asleep; and transmitting a communication to the home security system, wherein the communication includes a command to activate the home security system.

In alternative aspects, determining that the user has fallen asleep includes comparing the characteristic data to previous characteristic data, wherein the previous characteristic data indicates that the user had not fallen asleep. In alternative aspects, determining that the user has fallen asleep is based on detecting that a portion of the user has remained at a particular orientation for a period of time longer than a threshold time.

### BRIEF DESCRIPTION OF THE DRAWINGS

A further understanding of the nature and advantages of the disclosed embodiments may be realized by reference to the remaining portions of the specification and the drawings.

FIG. 1 shows a simplified media service system that may be used in accordance with embodiments of the present technology.

FIG. 2 illustrates an exemplary electronic device that may be used in accordance with embodiments of the present technology.

FIG. 3 illustrates an exemplary home automation system setup in accordance with embodiments of the present technology.

FIG. 4 illustrates an embodiment of a home automation system in accordance with embodiments of the present technology.

FIG. 5 illustrates an embodiment of a home automation engine using various communication paths to communicate with one or more mobile devices in accordance with embodiments of the present technology.

FIG. 6 illustrates an embodiment of a mobile device executing an application that monitors various communication paths in accordance with embodiments of the present technology.

FIG. 7 is a block diagram of a system including a television receiver and a wireless headset in accordance with embodiments of the present technology.

FIG. 8 is an illustration of a residential setting including a user wearing a wireless headset and operating a television receiver in accordance with embodiments of the present technology.

FIG. 9 is a block diagram of a wireless headset in accordance with embodiments of the present technology.

FIG. 10 is a block diagram of a television receiver in accordance with embodiments of the present technology.

FIG. 11A is an illustration of user wearing a wireless headset while awake in accordance with embodiments of the present technology.

FIG. 11B is an illustration of a user wearing a wireless headset while asleep in accordance with embodiments of the present technology.

FIG. 12 is an illustration of a television receiver monitoring a user wearing a wireless headset in accordance with embodiments of the present technology.

FIG. 13 is a flowchart illustrating a method for preserving batteries in a wireless headset in accordance with embodiments of the present technology.

FIG. 14 is a flowchart illustrating a method for preserving batteries in a wireless headset in accordance with embodiments of the present technology.

FIG. 15 is a block diagram of a system including a television receiver, security system device, and home automation device, in accordance with embodiments of the present technology

FIG. 16 illustrates a structure that includes a dwelling, a home automation system, and a home security system connected to the dwelling, according to embodiments of the present technology.

FIG. 17A is a block diagram of a home automation device, according to embodiments of the present technology.

FIG. 17B illustrates a flow diagram showing communications between devices within a home automation and/or security system, according to embodiments of the present technology.

FIG. 18 shows a graphical user interface (GUI) on a display connected to a home automation and security system, according to embodiments of the present technology.

FIG. 19 is a flow chart of another example process used to adjust a security system based on a user falling asleep, according to embodiments of the present technology.

FIG. 20 shows a simplified computer system that may be utilized to perform one or more of the operations discussed.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

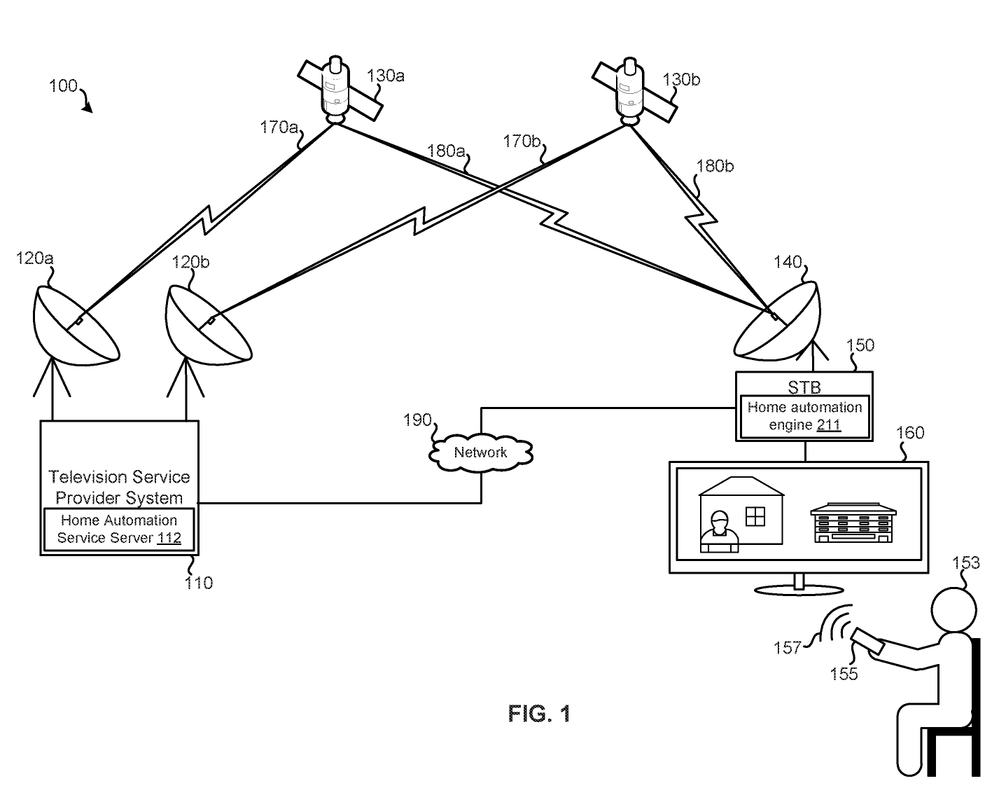

A television receiver may serve as a host for a home automation system. By using a television receiver to host a home automation system, various advantages may be realized. Many of these advantages are discussed below with respect to FIGS. 1-18.

FIG. 1 illustrates an embodiment of a satellite television distribution system 100. While a home automation system may be incorporated with various types of television receivers, various embodiments may be part of a satellite-based television distribution system. Cable, IP-based, wireless, and broadcast focused systems are also possible. Satellite television distribution system 100 may include: television service provider system 110, satellite transmitter equipment 120, satellites 130, satellite dish 140, television receiver 150, home automation service server 112, and display device 160. The display device 160 can be controlled by a user 153 using a remote control device 155 that can send wired or wireless signals 157 to communicate with the STB 150 and/or display device 160. Alternate embodiments of satellite television distribution system 100 may include fewer or greater numbers of components. While only one satellite dish 140, television receiver 150, and display device 160 (collectively referred to as “user equipment”) are illustrated, it should be understood that multiple (e.g., tens, thousands, millions of) instances and types of user equipment may receive data and television signals from television service provider system 110 via satellites 130.

Television service provider system 110 and satellite transmitter equipment 120 may be operated by a television service provider. A television service provider may distribute television channels, on-demand programming, programming information, and/or other content/services to users. Television service provider system 110 may receive feeds of one or more television channels and content from various sources. Such television channels may include multiple television channels that contain at least some of the same content (e.g., network affiliates). To distribute television channels for presentation to users, feeds of the television channels may be relayed to user equipment via multiple television distribution satellites. Each satellite may relay multiple transponder streams. Satellite transmitter equipment 120 may be used to transmit a feed of one or more television channels from television service provider system 110 to one or more satellites 130. While a single television service provider system 110 and satellite transmitter equipment 120 are illustrated as part of satellite television distribution system 100, it should be understood that multiple instances of transmitter equipment may be used, possibly scattered geographically, to communicate with satellites 130. Such multiple instances of satellite transmitting equipment may communicate with the same or with different satellites. Different television channels may be transmitted to satellites 130 from different instances of transmitting equipment. For instance, a different satellite dish of satellite transmitter equipment 120 may be used for communication with satellites in different orbital slots.

Satellites 130 may be configured to receive signals, such as streams of television channels, from one or more satellite uplinks such as satellite transmitter equipment 120. Satellites 130 may relay received signals from satellite transmitter equipment 120 (and/or other satellite transmitter equipment) to multiple instances of user equipment via transponder streams. Different frequencies may be used for uplink signals 170 from downlink signals 180. Satellites 130 may be in geosynchronous orbit. Each of the transponder streams transmitted by satellites 130 may contain multiple television channels transmitted as packetized data. For example, a single transponder stream may be a serial digital packet stream containing multiple television channels. Therefore, packets for multiple television channels may be interspersed. Further, information used by television receiver 150 for home automation functions may also be relayed to a television receiver via one or more transponder streams.

Multiple satellites 130 may be used to relay television channels from television service provider system 110 to satellite dish 140. Different television channels may be carried using different satellites. Different television channels may also be carried using different transponders of the same satellite; thus, such television channels may be transmitted at different frequencies and/or different frequency ranges. As an example, a first and second television channel may be relayed via a first transponder of satellite 130a. A third, fourth, and fifth television channel may be relayed via a different satellite or a different transponder of the same satellite relaying the transponder stream at a different frequency. A transponder stream transmitted by a particular transponder of a particular satellite may include a finite number of television channels, such as seven. Accordingly, if many television channels are to be made available for viewing and recording, multiple transponder streams may be necessary to transmit all of the television channels to the instances of user equipment.

Satellite dish 140 may be a piece of user equipment that is used to receive transponder streams from one or more satellites, such as satellites 130. Satellite dish 140 may be provided to a subscriber for use on a subscription basis to receive television channels provided by the television service provider system 110, satellite transmitter equipment 120, and/or satellites 130. Satellite dish 140, which may include one or more low noise blocks (LNBs), may be configured to receive transponder streams from multiple satellites and/or multiple transponders of the same satellite. Satellite dish 140 may be configured to receive television channels via transponder streams on multiple frequencies. Based on the characteristics of television receiver 150 and/or satellite dish 140, it may only be possible to capture transponder streams from a limited number of transponders concurrently. For example, a tuner of television receiver 150 may only be able to tune to a single transponder stream from a transponder of a single satellite at a given time. The tuner can then be re-tuned to another transponder of the same or a different satellite. A television receiver 150 having multiple tuners may allow for multiple transponder streams to be received at the same time.

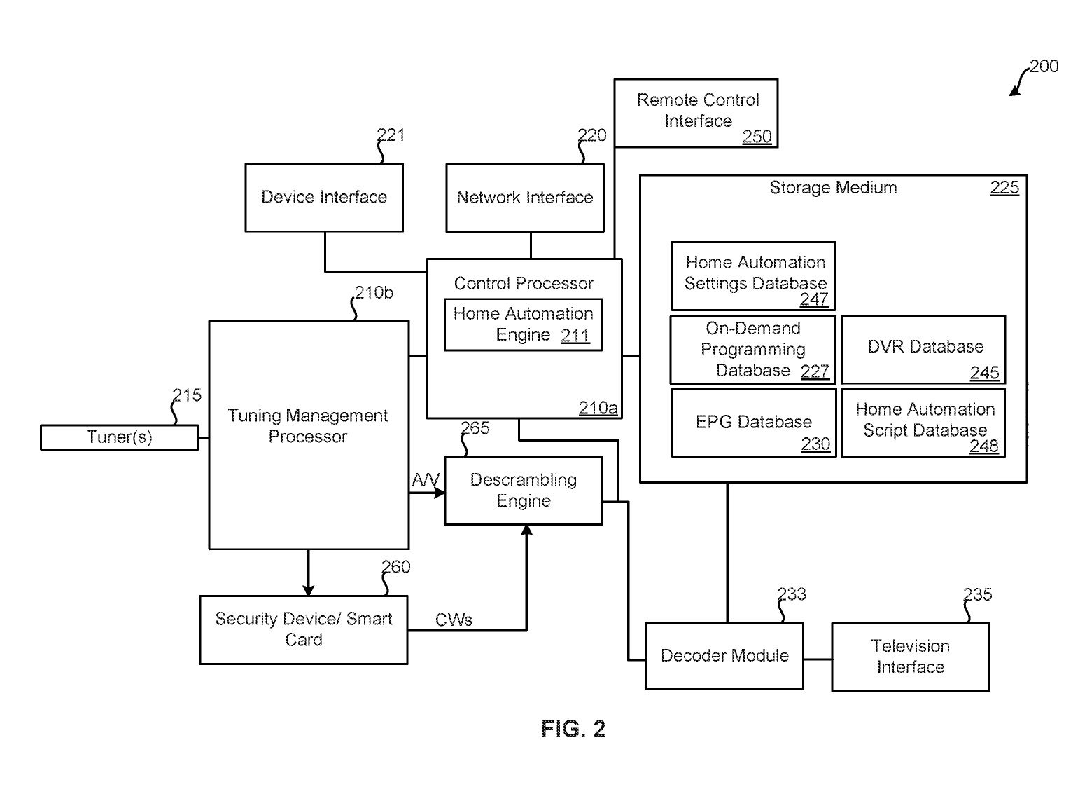

In communication with satellite dish 140 may be one or more television receivers. Television receivers may be configured to decode signals received from satellites 130 via satellite dish 140 for output and presentation via a display device, such as display device 160. A television receiver may be incorporated as part of a television or may be part of a separate device, commonly referred to as a set-top box (STB). Television receiver 150 may decode signals received via satellite dish 140 and provide an output to display device 160. On-demand content, such as PPV content, may be stored to a computer-readable storage medium. A television receiver is defined to include set-top boxes (STBs), and also circuitry having similar functionality that may be incorporated with another device. For instance, circuitry similar to that of a television receiver may be incorporated as part of a television. As such, while FIG. 1 illustrates an embodiment of television receiver 150 as separate from display device 160, it should be understood that, in other embodiments, similar functions may be performed by a television receiver integrated with display device 160. Television receiver 150 may include home automation engine 211, as detailed in relation to FIG. 2.

Display device 160 may be used to present video and/or audio decoded and output by television receiver 150. Television receiver 150 may also output a display of one or more interfaces to display device 160, such as an electronic programming guide (EPG). In many embodiments, display device 160 is a television. Display device 160 may also be a monitor, computer, or some other device configured to display video and, possibly, play audio.

Uplink signal 170a represents a signal between satellite transmitter equipment 120 and satellite 130a. Uplink signal 170b represents a signal between satellite transmitter equipment 120 and satellite 130b. Each of uplink signals 170 may contain streams of one or more different television channels. For example, uplink signal 170a may contain a first group of television channels, while uplink signal 170b contains a second group of television channels. Each of these television channels may be scrambled such that unauthorized persons are prevented from accessing the television channels.

Downlink signal 180a represents a signal between satellite 130a and satellite dish 140. Downlink signal 180b represents a signal between satellite 130b and satellite dish 140. Each of downlink signals 180 may contain one or more different television channels, which may be at least partially scrambled. A downlink signal may be in the form of a transponder stream. A single transponder stream may be tuned to at a given time by a tuner of a television receiver. For example, downlink signal 180a may be a first transponder stream containing a first group of television channels, while downlink signal 180b may be a second transponder stream containing a different group of television channels. In addition to or instead of containing television channels, a transponder stream can be used to transmit on-demand content to television receivers, including PPV content, which may be stored locally by the television receiver until output for presentation.

FIG. 1 illustrates downlink signal 180a and downlink signal 180b, being received by satellite dish 140 and distributed to television receiver 150. For a first group of television channels, satellite dish 140 may receive downlink signal 180a and for a second group of channels, downlink signal 180b may be received. Television receiver 150 may decode the received transponder streams. As such, depending on which television channels are desired to be presented or stored, various transponder streams from various satellites may be received, descrambled, and decoded by television receiver 150.

Network 190, which may include the Internet, may allow for bidirectional communication between television receiver 150 and television service provider system 110, such as for home automation related services provided by home automation service server 112. Although illustrated as part of the television service provider system, the home automation service server 112 may be provided by a third party in embodiments. In addition or in alternate to network 190, a telephone, e.g., landline, or cellular connection may be used to enable communication between television receiver 150 and television service provider system 110.

FIG. 2 illustrates an embodiment of a television receiver 200, which may represent television receiver 150 of FIG. 1. Television receiver 200 may be configured to function as a host for a home automation system either alone or in conjunction with a communication device. Television receiver 200 may be in the form of a separate device configured to be connected with a display device, such as a television. Embodiments of television receiver 200 can include set top boxes (STBs). In addition to being in the form of an STB, a television receiver may be incorporated as part of another device, such as a television, other form of display device, video game console, computer, mobile phone or tablet, or the like. For example, a television may have an integrated television receiver, which does not involve an external STB being coupled with the television.

Television receiver 200 may be incorporated as part of a television, such as display device 160 of FIG. 1. Television receiver 200 may include: processors 210, which may include control processor 210a, tuning management processor 210b, and possibly additional processors, tuners 215, network interface 220, non-transitory computer-readable storage medium 225, electronic programming guide (EPG) database 230, television interface 235, digital video recorder (DVR) database 245, which may include provider-managed television programming storage and/or user-defined television programming, on-demand programming database 227, home automation settings database 247, home automation script database 248, remote control interface 250, security device 260, and/or descrambling engine 265. In other embodiments of television receiver 200, fewer or greater numbers of components may be present. It should be understood that the various components of television receiver 200 may be implemented using hardware, firmware, software, and/or some combination thereof. Functionality of components may be combined; for example, functions of descrambling engine 265 may be performed by tuning management processor 210b. Further, functionality of components may be spread among additional components.

Processors 210 may include one or more specialized and/or general-purpose processors configured to perform processes such as tuning to a particular channel, accessing and displaying EPG information from EPG database 230, and/or receiving and processing input from a user. It should be understood that the functions performed by various modules of FIG. 2 may be performed using one or more processors. As such, for example, functions of descrambling engine 265 may be performed by control processor 210a.

Control processor 210a may communicate with tuning management processor 210b. Control processor 210a may control the recording of television channels based on timers stored in DVR database 245. Control processor 210a may also provide commands to tuning management processor 210b when recording of a television channel is to cease. In addition to providing commands relating to the recording of television channels, control processor 210a may provide commands to tuning management processor 210b that indicate television channels to be output to decoder module 233 for output to a display device. Control processor 210a may also communicate with network interface 220 and remote control interface 250. Control processor 210a may handle incoming data from network interface 220 and remote control interface 250. Additionally, control processor 210a may be configured to output data via network interface 220.

Control processor 210a may include home automation engine 211. Home automation engine 211 may permit television receiver and control processor 210a to provide home automation functionality. Home automation engine 211 may have a JSON (JavaScript Object Notation) command interpreter or some other form of command interpreter that is configured to communicate with wireless devices via network interface 220 and a message server, possibly via a message server client. Such a command interpreter of home automation engine 211 may also communicate via a local area network with devices without using the Internet. Home automation engine 211 may contain multiple controllers specific to different protocols; for instance, a ZigBee® controller, a Z-Wave® controller, and/or an IP camera controller, wireless LAN, 802.11, may be present. Home automation engine 211 may contain a media server configured to serve streaming audio and/or video to remote devices on a local area network or the Internet. Television receiver may be able to serve such devices with recorded content, live content, and/or content recorded using one or more home automation devices, such as cameras.

Tuners 215 may include one or more tuners used to tune to transponders that include broadcasts of one or more television channels. Such tuners may be used also to receive for storage on-demand content and/or addressable television commercials. In some embodiments, two, three, or more than three tuners may be present, such as four, six, or eight tuners. Each tuner contained in tuners 215 may be capable of receiving and processing a single transponder stream from a satellite transponder or from a cable network at a given time. As such, a single tuner may tune to a single transponder stream at a given time. If tuners 215 include multiple tuners, one tuner may be used to tune to a television channel on a first transponder stream for display using a television, while another tuner may be used to tune to a television channel on a second transponder for recording and viewing at some other time. If multiple television channels transmitted on the same transponder stream are desired, a single tuner of tuners 215 may be used to receive the signal containing the multiple television channels for presentation and/or recording. Tuners 215 may receive commands from tuning management processor 210b. Such commands may instruct tuners 215 to which frequencies are to be tuned.

Network interface 220 may be used to communicate via an alternate communication channel with a television service provider, if such communication channel is available. A communication channel may be via satellite, which may be unidirectional to television receiver 200, and the alternate communication channel, which may be bidirectional, may be via a network, such as the Internet. Data may be transmitted from television receiver 200 to a television service provider system and from the television service provider system to television receiver 200. Information may be transmitted and/or received via network interface 220. For instance, instructions from a television service provider may also be received via network interface 220, if connected with the Internet. Besides the primary communication channel being satellite, cable network, an IP-based network, or broadcast network may be used. Network interface 220 may permit wireless communication with one or more types of networks, including using home automation network protocols and wireless network protocols. Also, wired networks may be connected to and communicated with via network interface 220. Device interface 221 may represent a USB port or some other form of communication port that permits communication with a communication device as will be explained further below.

Storage medium 225 may represent one or more non-transitory computer-readable storage mediums. Storage medium 225 may include memory and/or a hard drive. Storage medium 225 may be used to store information received from one or more satellites and/or information received via network interface 220. Storage medium 225 may store information related to on-demand programming database 227, EPG database 230, DVR database 245, home automation settings database 247, and/or home automation script database 248. Recorded television programs may be stored using storage medium 225 as part of DVR database 245. Storage medium 225 may be partitioned or otherwise divided, such as into folders, such that predefined amounts of storage medium 225 are devoted to storage of television programs recorded due to user-defined timers and stored television programs recorded due to provider-defined timers.

Home automation settings database 247 may allow configuration settings of home automation devices and user preferences to be stored. Home automation settings database 247 may store data related to various devices that have been set up to communicate with television receiver 200. For instance, home automation settings database 247 may be configured to store information on which types of events should be indicated to users, to which users, in what order, and what communication methods should be used. For instance, an event such as an open garage may only be notified to certain wireless devices, e.g., a cellular phone associated with a parent, not a child, notification may be by a third-party notification server, email, text message, and/or phone call. In some embodiments, a second notification method may only be used if a first fails. For instance, if a notification cannot be sent to the user via a third-party notification server, an email may be sent.

Home automation settings database 247 may store information that allows for the configuration and control of individual home automation devices which may operate using Z-wave and Zigbee-specific protocols. To do so, home automation engine 211 may create a proxy for each device that allows for settings for the device to be passed through a UI, e.g, presented on a television, to allow for settings to be solicited for and collected via a user interface presented by television receiver or overlay device. The received settings may then be handled by the proxy specific to the protocol, allowing for the settings to be passed on to the appropriate device. Such an arrangement may allow for settings to be collected and received via a UI of the television receiver or overlay device and passed to the appropriate home automation device and/or used for managing the appropriate home automation device. For example, a piece of exercise equipment that is enabled to interface with the home automation engine 211, such as via device interface 221, may be configured at the electronic device 211 in addition to on the piece of exercise equipment itself. Additionally, a mobile device or application residing on a mobile device and utilized with exercise equipment may be configured in such a fashion as well for displaying received fitness information on a coupled display device.

Home automation script database 248 may store scripts that detail how home automation devices are to function based on various events occurring. For instance, if stored content starts being played back by television receiver 200, lights in the vicinity of display device 160 may be dimmed and shades may be lowered by communicatively coupled and controlled shade controller. As another example, when a user shuts programming off late in the evening, there may be an assumption the user is going to bed. Therefore, the user may configure television receiver 200 to lock all doors via a lock controller, shut the garage door via garage controller, lower a heat setting of thermostat, shut off all lights via a light controller, and determine if any windows or doors are open via window sensors and door sensors, and, if so, alert the user. Such scripts or programs may be predefined by the home automation/television service provider and/or may be defined by a user.

In some embodiments, home automation script database 248 may allow for various music profiles to be implemented. For instance, based on home automation settings within a structure, appropriate music may be played. For instance, when a piece of exercise equipment is connected or is used, energizing music may be played. Conversely, based on the music being played, settings of home automation devices may be determined. If television programming, such as a movie, is output for playback by television receiver 150, a particular home automation script may be used to adjust home automation settings, e.g., lower lights, raise temperature, and lock doors.

EPG database 230 may store information related to television channels and the timing of programs appearing on such television channels. EPG database 230 may be stored using storage medium 225, which may be a hard drive or solid-state drive. Information from EPG database 230 may be used to inform users of what television channels or programs are popular and/or provide recommendations to the user. Information from EPG database 230 may provide the user with a visual interface displayed by a television that allows a user to browse and select television channels and/or television programs for viewing and/or recording. Information used to populate EPG database 230 may be received via network interface 220, via satellite, or some other communication link with a television service provider, e.g., a cable network. Updates to EPG database 230 may be received periodically. EPG database 230 may serve as an interface for a user to control DVR functions of television receiver 200, and/or to enable viewing and/or recording of multiple television channels simultaneously. EPG database 240 may also contain information about on-demand content or any other form of accessible content.

Decoder module 233 may serve to convert encoded video and audio into a format suitable for output to a display device. For instance, decoder module 233 may receive MPEG video and audio from storage medium 225 or descrambling engine 265 to be output to a television. MPEG video and audio from storage medium 225 may have been recorded to DVR database 245 as part of a previously-recorded television program. Decoder module 233 may convert the MPEG video and audio into a format appropriate to be displayed by a television or other form of display device and audio into a format appropriate to be output from speakers, respectively. Decoder module 233 may have the ability to convert a finite number of television channel streams received from storage medium 225 or descrambling engine 265, simultaneously. For instance, decoders within decoder module 233 may be able to only decode a single television channel at a time. Decoder module 233 may have various numbers of decoders.

Television interface 235 may serve to output a signal to a television or another form of display device in a proper format for display of video and playback of audio. As such, television interface 235 may output one or more television channels, stored television programming from storage medium 225, e.g., television programs from DVR database 245, television programs from on-demand programming 230 and/or information from EPG database 230, to a television for presentation. Television interface 235 may also serve to output a CVM.

Digital Video Recorder (DVR) functionality may permit a television channel to be recorded for a period of time. DVR functionality of television receiver 200 may be managed by control processor 210a. Control processor 210a may coordinate the television channel, start time, and stop time of when recording of a television channel is to occur. DVR database 245 may store information related to the recording of television channels. DVR database 245 may store timers that are used by control processor 210a to determine when a television channel should be tuned to and its programs recorded to DVR database 245 of storage medium 225. In some embodiments, a limited amount of storage medium 225 may be devoted to DVR database 245. Timers may be set by the television service provider and/or one or more users of television receiver 200.

DVR database 245 may also be used to record recordings of service provider-defined television channels. For each day, an array of files may be created. For example, based on provider-defined timers, a file may be created for each recorded television channel for a day. For example, if four television channels are recorded from 6-10 PM on a given day, four files may be created; one for each television channel. Within each file, one or more television programs may be present. The service provider may define the television channels, the dates, and the time periods for which the television channels are recorded for the provider-defined timers. The provider-defined timers may be transmitted to television receiver 200 via the television provider's network. For example, in a satellite-based television service provider system, data necessary to create the provider-defined timers at television receiver 150 may be received via satellite.

On-demand programming database 227 may store additional television programming. On-demand programming database 227 may include television programming that was not recorded to storage medium 225 via a timer, either user- or provider-defined. Rather, on-demand programming may be programming provided to the television receiver directly for storage by the television receiver and for later presentation to one or more users. On-demand programming may not be user-selected. As such, the television programming stored to on-demand programming database 227 may be the same for each television receiver of a television service provider. On-demand programming database 227 may include pay-per-view (PPV) programming that a user must pay and/or use an amount of credits to view. For instance, on-demand programming database 227 may include movies that are not available for purchase or rental yet.

Referring back to tuners 215, television channels received via satellite or cable may contain at least some scrambled data. Packets of audio and video may be scrambled to prevent unauthorized users, e.g., nonsubscribers, from receiving television programming without paying the television service provider. When a tuner of tuners 215 is receiving data from a particular transponder of a satellite, the transponder stream may be a series of data packets corresponding to multiple television channels. Each data packet may contain a packet identifier (PID), which can be determined to be associated with a particular television channel. Particular data packets, referred to as entitlement control messages (ECMs), may be periodically transmitted. ECMs may be associated with another PID and may be encrypted; television receiver 200 may use decryption engine 261 of security device 260 to decrypt ECMs. Decryption of an ECM may only be possible if the user has authorization to access the particular television channel associated with the ECM. When an ECM is determined to correspond to a television channel being stored and/or displayed, the ECM may be provided to security device 260 for decryption.

When security device 260 receives an encrypted ECM, security device 260 may decrypt the ECM to obtain some number of control words. In some embodiments, from each ECM received by security device 260, two control words are obtained. In some embodiments, when security device 260 receives an ECM, it compares the ECM to the previously received ECM. If the two ECMs match, the second ECM is not decrypted because the same control words would be obtained. In other embodiments, each ECM received by security device 260 is decrypted; however, if a second ECM matches a first ECM, the outputted control words will match; thus, effectively, the second ECM does not affect the control words output by security device 260. Security device 260 may be permanently part of television receiver 200 or may be configured to be inserted and removed from television receiver 200, such as a smart card, cable card, or the like.

Tuning management processor 210b may be in communication with tuners 215 and control processor 210a. Tuning management processor 210b may be configured to receive commands from control processor 210a. Such commands may indicate when to start/stop receiving and/or recording of a television channel and/or when to start/stop causing a television channel to be output to a television. Tuning management processor 210b may control tuners 215. Tuning management processor 210b may provide commands to tuners 215 that instruct the tuners which satellite, transponder, and/or frequency to tune to. From tuners 215, tuning management processor 210b may receive transponder streams of packetized data.

Descrambling engine 265 may use the control words output by security device 260 in order to descramble video and/or audio corresponding to television channels for storage and/or presentation. Video and/or audio data contained in the transponder data stream received by tuners 215 may be scrambled. Video and/or audio data may be descrambled by descrambling engine 265 using a particular control word. Which control word output by security device 260 to be used for successful descrambling may be indicated by a scramble control identifier present within the data packet containing the scrambled video or audio. Descrambled video and/or audio may be output by descrambling engine 265 to storage medium 225 for storage, in DVR database 245, and/or to decoder module 233 for output to a television or other presentation equipment via television interface 235.

In some embodiments, the television receiver 200 may be configured to periodically reboot in order to install software updates downloaded over the network 190 or satellites 130. Such reboots may occur for example during the night when the users are likely asleep and not watching television. If the system utilizes a single processing module to provide television receiving and home automation functionality, then the security functions may be temporarily deactivated. In order to increase the security of the system, the television receiver 200 may be configured to reboot at random times during the night in order to allow for installation of updates. Thus, an intruder is less likely to guess the time when the system is rebooting. In some embodiments, the television receiver 200 may include multiple processing modules for providing different functionality, such as television receiving functionality and home automation, such that an update to one module does not necessitate reboot of the whole system. In other embodiments, multiple processing modules may be made available as a primary and a backup during any installation or update procedures.

For simplicity, television receiver 200 of FIG. 2 has been reduced to a block diagram; commonly known parts, such as a power supply, have been omitted. Further, some routing between the various modules of television receiver 200 has been illustrated. Such illustrations are for exemplary purposes only. The state of two modules not being directly or indirectly connected does not indicate the modules cannot communicate. Rather, connections between modules of the television receiver 200 are intended only to indicate possible common data routing. It should be understood that the modules of television receiver 200 may be combined into a fewer number of modules or divided into a greater number of modules. Further, the components of television receiver 200 may be part of another device, such as built into a television. Television receiver 200 may include one or more instances of various computerized components.

While the television receiver 200 has been illustrated as a satellite-based television receiver, it is to be appreciated that techniques below may be implemented in other types of television receiving devices, such a cable receivers, terrestrial receivers, IPTV receivers or the like. In some embodiments, the television receiver 200 may be configured as a hybrid receiving device, capable of receiving content from disparate communication networks, such as satellite and terrestrial television broadcasts. In some embodiments, the tuners may be in the form of network interfaces capable of receiving content from designated network locations. The home automation functions of television receiver 200 may be performed by an overlay device. If such an overlay device is used, television programming functions may still be provided by a television receiver that is not used to provide home automation functions.

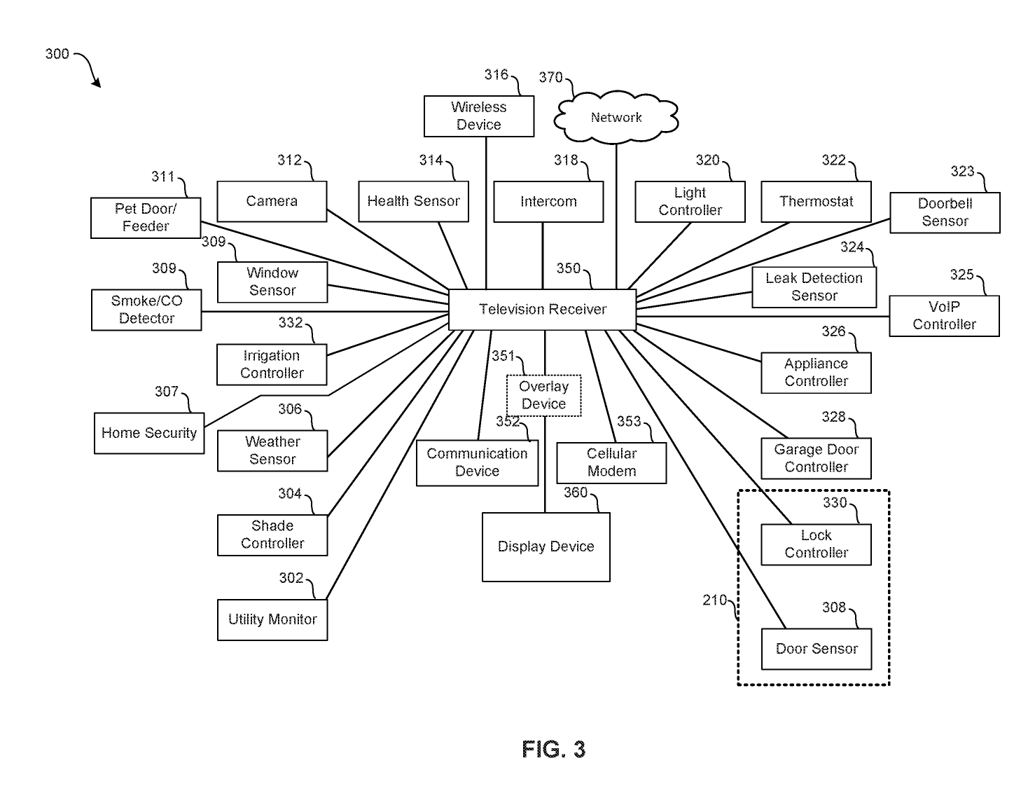

FIG. 3 illustrates an embodiment of a home automation system 300 hosted by a television receiver. Television receiver 350 may be configured to receive television programming from a satellite-based television service provider; in other embodiments other forms of television service provider networks may be used, such as an IP-based network (e.g., fiber network), a cable based network, a wireless broadcast-based network, etc.

Television receiver 350 may be configured to communicate with multiple in-home home automation devices. The devices with which television receiver 350 communicates may use different communication standards. For instance, one or more devices may use a ZigBee® communication protocol while one or more other devices communicate with the television receiver using a Z-Wave® communication protocol. Other forms of wireless communication may be used by devices and the television receiver. For instance, television receiver 350 and one or more devices may be configured to communicate using a wireless local area network, which may use a communication protocol such as IEEE 802.11.

In some embodiments, a separate device may be connected with television receiver 350 to enable communication with home automation devices. For instance, communication device 352 may be attached to television receiver 350. Communication device 352 may be in the form of a dongle. Communication device 352 may be configured to allow for Zigbee®, Z-Wave®, and/or other forms of wireless communication. The communication device may connect with television receiver 350 via a USB port or via some other type of (wired) communication port. Communication device 352 may be powered by the television receiver or may be separately coupled with a power source. In some embodiments, television receiver 350 may be enabled to communicate with a local wireless network and may use communication device 352 in order to communicate with devices that use a ZigBee® communication protocol, Z-Wave® communication protocol, and/or some other home wireless communication protocols.

Communication device 352 may also serve to allow additional components to be connected with television receiver 350. For instance, communication device 352 may include additional audio/video inputs (e.g., HDMI), a component, and/or a composite input to allow for additional devices (e.g., Blu-ray players) to be connected with television receiver 350. Such connection may allow video from such additional devices to be overlaid with home automation information. Whether home automation information is overlaid onto video may be triggered based on a user's press of a remote control button.

Regardless of whether television receiver 350 uses communication device 352 to communicate with home automation devices, television receiver 350 may be configured to output home automation information for presentation to a user via display device 360, which may be a television, monitor, or other form of device capable of presenting visual information. Such information may be presented simultaneously with television programming received by television receiver 350. Television receiver 350 may also, at a given time, output only television programming or only home automation information based on a user's preference. The user may be able to provide input to television receiver 350 to control the home automation system hosted by television receiver 350 or by overlay device 351, as detailed below.

In some embodiments, television receiver 350 may not be used as a host for a home automation system. Rather, a separate device may be coupled with television receiver 350 that allows for home automation information to be presented to a user via display device 360. This separate device may be coupled with television receiver 350. In some embodiments, the separate device is referred to as overlay device 351. Overlay device 351 may be configured to overlay information, such as home automation information, onto a signal to be visually presented via display device 360, such as a television. In some embodiments, overlay device 351 may be coupled between television receiver 350, which may be in the form of a set top box, and display device 360, which may be a television. In such embodiments, television receiver 350 may receive, decode, descramble, decrypt, store, and/or output television programming. Television receiver 350 may output a signal, such as in the form of an HDMI signal. Rather than be directly input to display device 360, the output of television receiver 350 may be input to overlay device 351. Overlay device 351 may receive the video and/or audio output from television receiver 350. Overlay device 351 may add additional information to the video and/or audio signal received from television receiver 350. The modified video and/or audio signal may be output to display device 360 for presentation. In some embodiments, overlay device 351 has an HDMI input and an HDMI output, with the HDMI output being connected to display device 360. To be clear, while FIG. 3 illustrates lines illustrating communication between television receiver 350 and various devices, it should be understood that such communication may exist, in addition or alternatively via communication device 352 and/or with overlay device 351.

In some embodiments, television receiver 350 may be used to provide home automation functionality but overlay device 351 may be used to present information via display device 360. It should be understood that the home automation functionality detailed herein in relation to a television receiver may alternatively be provided via overlay device 351. In some embodiments, overlay device 351 may provide home automation functionality and be used to present information via display device 360. Using overlay device 351 to present automation information via display device 360 may have additional benefits. For instance, multiple devices may provide input video to overlay device 351. For instance, television receiver 350 may provide television programming to overlay device 351, a DVD/Blu-Ray player may provide video overlay device 351, and a separate internet-TV device may stream other programming to overlay device 351. Regardless of the source of the video/audio, overlay device 351 may output video and/or audio that has been modified to include home automation information and output to display device 360. As such, in such embodiments, regardless of the source of video/audio, overlay device 351 may modify the audio/video to include home automation information and, possibly, solicit for user input. For instance, in some embodiments, overlay device 351 may have four video inputs (e.g., four HDMI inputs) and a single video output (e.g., an HDMI output). In other embodiments, such overlay functionality may be part of television receiver 350. As such, a separate device, such as a Blu-ray player, may be connected with a video input of television receiver 350, thus allowing television receiver 350 to overlay home automation information when content from the Blu-Ray player is being output to display device 360.

Regardless of whether television receiver 350 is itself configured to provide home automation functionality and output home automation input for display via display device 360 or such home automation functionality is provided via overlay device 351, home automation information may be presented by display device 360 while television programming is also being presented by display device 360. For instance, home automation information may be overlaid or may replace a portion of television programming (e.g., broadcast content, stored content, on-demand content, etc.) presented via display device 360.

Television receiver 350 or overlay device 351 may be configured to communicate with one or more wireless devices, such as wireless device 316. Wireless device 316 may represent a tablet computer, cellular phone, laptop computer, remote computer, or some other device through which a user may desire to control home automation settings and view home automation information. Such a device also need not be wireless, such as a desktop computer. Television receiver 350, communication device 352, or overlay device 351 may communicate directly with wireless device 316, or may use a local wireless network, such as network 370. Wireless device 316 may be remotely located and not connected with a same local wireless network. Via the internet, television receiver 350 or overlay device 351 may be configured to transmit a notification to wireless device 316 regarding home automation information. For instance, in some embodiments, a third-party notification server system, such as the notification server system operated by Apple®, may be used to send such notifications to wireless device 316.

In some embodiments, a location of wireless device 316 may be monitored. For instance, if wireless device 316 is a cellular phone, when its position indicates it has neared a door, the door may be unlocked. A user may be able to define which home automation functions are controlled based on a position of wireless device 316. Other functions could include opening and/or closing a garage door, adjusting temperature settings, turning on and/or off lights, opening and/or closing shades, etc. Such location-based control may also take into account the detection of motion via one or more motion sensors that are integrated into other home automation devices and/or stand-alone motion sensors in communication with television receiver 350.

In some embodiments, little to no setup of network 370 may be necessary to permit television receiver 350 to stream data out to the Internet. For instance, television receiver 350 and network 370 may be configured, via a service such as Sling® or other video streaming service, to allow for video to be streamed from television receiver 350 to devices accessible via the Internet. Such streaming capabilities may be “piggybacked” to allow for home automation data to be streamed to devices accessible via the Internet. For example, U.S. patent application Ser. No. 12/645,870, filed on Dec. 23, 2009, entitled “Systems and Methods for Remotely Controlling a Media Server via a Network”, which is hereby incorporated by reference, describes one such system for allowing remote access and control of a local device. U.S. Pat. No. 8,171,148, filed Apr. 17, 2009, entitled “Systems and Methods for Establishing Connections Between Devices Communicating Over a Network”, which is hereby incorporated by reference, describes a system for establishing connection between devices over a network. U.S. patent application Ser. No. 12/619,192, filed May 19, 2011, entitled “Systems and Methods for Delivering Messages Over a Network”, which is hereby incorporated by reference, describes a message server that provides messages to clients located behind a firewall.

Wireless device 316 may serve as an input device for television receiver 350. For instance, wireless device 316 may be a tablet computer that allows text to be typed by a user and provided to television receiver 350. Such an arrangement may be useful for text messaging, group chat sessions, or any other form of text-based communication. Other types of input may be received for the television receiver from a tablet computer or other device as shown in the attached screenshots, such as lighting commands, security alarm settings and door lock commands. While wireless device 316 may be used as the input device for typing text, television receiver 350 may output for display text to display device 360.

In some embodiments, a cellular modem 353 may be connected with either overlay device 351 or television receiver 350. Cellular modem 353 may be useful if a local wireless network is not available. For instance, cellular modem 353 may permit access to the internet and/or communication with a television service provider. Communication with a television service provider may also occur via a local wireless or wired network connected with the Internet. In some embodiments, information for home automation purposes may be transmitted by a television service provider system to television receiver 350 or overlay device 351 via the television service provider's distribution network.

Various home automation devices may be in communication with television receiver 350 or overlay device 351. Such home automation devices may use disparate communication protocols. Such home automation devices may communicate with television receiver 350 directly or via communication device 352. Such home automation devices may be controlled by a user and/or have a status viewed by a user via display device 360 and/or wireless device 316. Home automation devices may include: smoke/carbon monoxide detector, home security system 307, pet door/feeder 311, camera 312, window sensor 309, irrigation controller 332, weather sensor 306, shade controller 304, utility monitor 302, heath sensor 314, intercom 318, light controller 320, thermostat 322, leak detection sensor 324, appliance controller 326, garage door controller 328, doorbell sensor 323, and VoIP controller 325.

Door sensor 308 and lock controller 330 may be incorporated into a single device, such as a door lock or sensor unit, and may allow for a door's position (e.g., open or closed) to be determined and for a lock's state to be determined and changed. Door sensor 308 may transmit data to television receiver 350 (possibly via communication device 352) or overlay device 251 that indicates the status of a window or door, respectively. Such status may indicate open or closed. When a status change occurs, the user may be notified as such via wireless device 316 or display device 360. Further, a user may be able to view a status screen to view the status of one or more door sensors throughout the location. Window sensor 309 and/or door sensor 308 may have integrated glass break sensors to determine if glass has been broken. Lock controller 330 may permit a door to be locked and unlocked and/or monitored by a user via television receiver 350 or overlay device 351. No mechanical or electrical component may need to be integrated separately into a door or door frame to provide such functionality. Such a single device may have a single power source that allows for sensing of the lock position, sensing of the door position, and for engagement and disengagement of the lock.

Additional forms of sensors not illustrated in FIG. 3 may also be incorporated as part of a home automation system. For instance, a mailbox sensor may be attached to a mailbox to determine when mail is present and/or has been picked up. The ability to control one or more showers, baths, and/or faucets from television receiver 350 and/or wireless device 316 may also be possible. Pool and/or hot tub monitors may be incorporated into a home automation system. Such sensors may detect whether or not a pump is running, water temperature, pH level, a splash/whether something has fallen in, etc. Further, various characteristics of the pool and/or hot tub may be controlled via the home automation system. In some embodiments, a vehicle dashcam may upload or otherwise make video/audio available to television receiver 350 when within range. For instance, when a vehicle has been parked within range of a local wireless network with which television receiver 350 is connected, video and/or audio may be transmitted from the dashcam to the television receiver for storage and/or uploading to a remote server.

To be clear, the home automation functions detailed herein that are attributed to television receiver 350 may alternatively or additionally be incorporated into overlay device 351 or some separate computerized home automation host system.

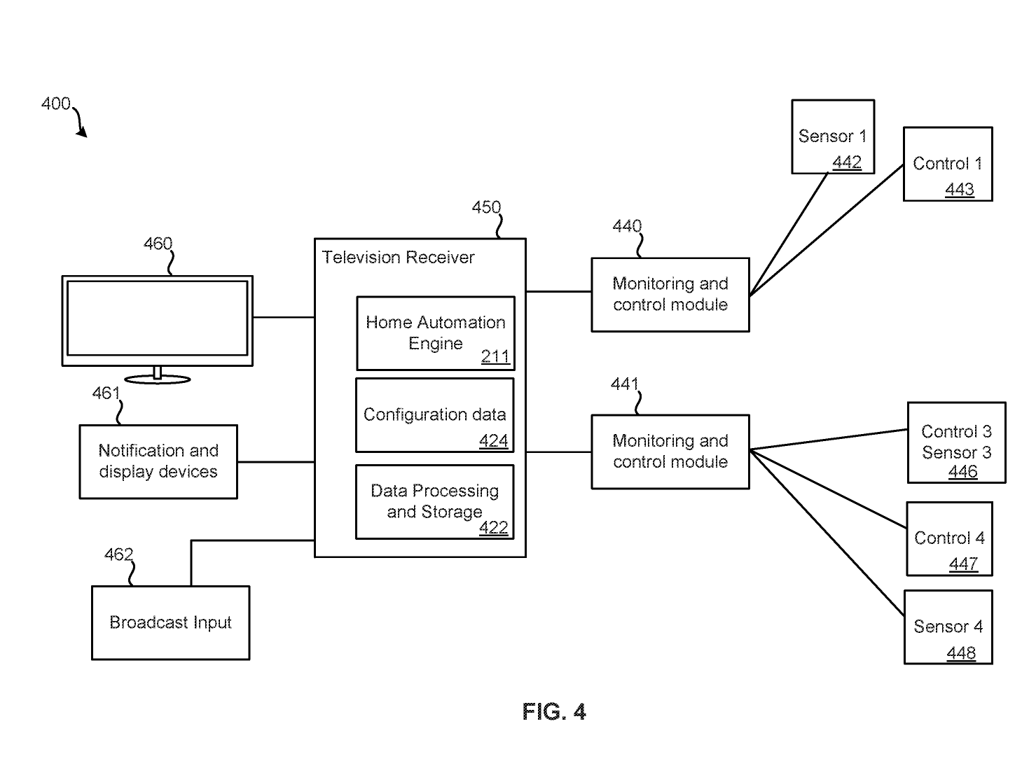

FIG. 4 shows an embodiment of a system for home monitoring and control that includes a television receiver 450. The system 400 may include a television receiver that is directly or indirectly coupled to one or more display devices 460 such as a television or a monitor. The television receiver may be communicatively coupled to other display and notification devices 461 such as stereo systems, speakers, lights, mobile phones, tablets, and the like. The television receiver may be configured to receive readings from one or more sensors 442, 448, or sensor systems 446 and may be configured to provide signals for controlling one or more control units 443, 447 or control systems 446.

In embodiments the television receiver may include a monitoring and control module 440, 441 and may be directly or indirectly connected or coupled to one or more sensors and/or control units. Sensors and control units may be wired or wirelessly coupled with the television receiver. The sensors and control units may be coupled and connected in a serial, parallel, star, hierarchical, and/or the like topologies and may communicate to the television receiver via one or more serial, bus, or wireless protocols and technologies which may include, for example, WiFi, CAN bus, Bluetooth, I2C bus, ZigBee, Z-Wave and/or the like.

The system may include one or more monitoring and control modules 440, 441 that are external to the television receiver 450. The television receiver may interface to sensors and control units via one or more of the monitoring and control modules. The external monitoring and control modules 440, 441 may be wired or wirelessly coupled with the television receiver. In some embodiments, the monitoring and control modules may connect to the television receiver via a communication port such as a USB port, serial port, and/or the like, or may connect to the television receiver via a wireless communication protocol such as Wi-Fi, Bluetooth, Z-Wave, ZigBee, and the like. The external monitoring and control modules may be a separate device that may be positioned near the television receiver or may be in a different location, remote from the television receiver.

In embodiments, the monitoring and control modules 440, 441 may provide protocol, communication, and interface support for each sensor and/or control unit of the system. The monitoring and control module may receive and transmit readings and provide a low level interface for controlling and/or monitoring the sensors and/or control units. The readings processed by the monitoring and control modules 440, 441 may be used by the other elements of the television receiver. For example, in some embodiments the readings from the monitoring and control modules may be logged and analyzed by the data processing and storage 422 module. The data processing and storage 422 module may analyze the received data and generate control signals, schedules, and/or sequences for controlling the control units. Additionally, the data processing and storage module 422 may utilize input data to generate additional outputs. For example, the module 422 may receive from a sensor 442 information from a communicatively coupled piece of equipment. The sensor may be a part of or attached to the equipment in various embodiments. The equipment may provide information regarding movements, alarms, or notifications associated with the home, and the data processing module 422 may use this data to generate relative distance information to be output to and displayed by display device 460. In some embodiments, the monitoring and control modules 440, 441 may be configured to receive and/or send digital signals and commands to the sensors and control units. The monitoring and control modules may be configured to receive and/or send analog signals and commands to the sensors and control units.

Sensors and control units may be wired or wirelessly coupled to the monitoring and control modules 440, 441 or directly or indirectly coupled with the receiver 450 itself. The sensors and control units may be coupled and connected in a serial, parallel, star, hierarchical, and/or the like topologies and may communicate to the monitoring and control modules via one or more serial, bus, or wireless protocols and technologies. The sensors may include any number of temperature, humidity, sound, proximity, field, electromagnetic, magnetic sensors, cameras, infrared detectors, motion sensors, pressure sensors, smoke sensors, fire sensors, water sensors, and/or the like. The sensors may also be part of or attached to other pieces of equipment, such as exercise equipment, doors or windows, or home appliances, or may be applications or other sensors as part of mobile devices.

The monitoring and control modules 440, 441 may be coupled with one or more control units. The control units may include any number of switches, solenoids, solid state devices and/or the like for making noise, turning on/off electronics, heating and cooling elements, controlling appliances, HVAC systems, lights, and/or the like. For example, a control unit may be a device that plugs into an electrical outlet of a home. Other devices, such as an appliance, may be plugged into the device. The device may be controlled remotely to enable or disable electricity to flow to the appliance. A control unit may also be part of an appliance, heating or cooling system, and/or other electric or electronic devices. In embodiments the control units of other system may be controlled via a communication or control interface of the system. For example, the water heater temperature setting may be configurable and/or controlled via a communication interface of the water heater or home furnace. Additionally, received telephone calls may be answered or pushed to voicemail in embodiments.

The controllers, e.g., controller 443, may include a remote control designed for association with the television receiver. For example, the receiver remote control device may be communicatively coupled with the television receiver, such as through interface 250, or one or more of the monitoring and control modules for providing control or instruction for operation of the various devices of the system. The control may be utilized to provide instructions to the receiver for providing various functions with the automation system including suspending alert notifications during an event. For example, a user may determine prior to or during an event that he wishes to suspend one or more types of notifications until the event has ended, and may so instruct the system with the controller.

Sensors may be part of other devices and/or systems. For example, sensors may be part of a mobile device such as a phone. The telemetry readings of the sensors may be accessed through a wireless communication interface such as a Bluetooth connection from the phone. As another example, temperature sensors may be part of a heating and ventilation system of a home. The readings of the sensors may be accessed via a communication interface of the heating and ventilation system. Sensors and/or control units may be combined into assemblies or units with multiple sensing capabilities and/or control capabilities. A single module may include, for example a temperature sensor and humidity sensor. Another module may include a light sensor and power or control unit and so on.

In embodiments, the sensors and control units may be configurable or adjustable. In some cases the sensors and control units may be configurable or adjustable for specific applications. The sensors and control units may be adjustable by mechanical or manual means. In some cases the sensors and control units may be electronically adjustable from commands or instructions sent to the sensors or control units. For example, the focal length of a camera may be configurable in some embodiments. The focal length of a camera may be dependent on the application of the camera. In some embodiments the focal length may be manually set or adjusted by moving or rotating a lens. In some embodiments the focal length may be adjusted via commands that cause an actuator to move one or more lenses to change the focal length. In other embodiments, the sensitivity, response, position, spectrum and/or like of the sensors may be adjustable.

During operation of the system 400, readings from the sensors may be collected, stored, and/or analyzed in the television receiver 450. In embodiments, analysis of the sensors and control of the control units may be determined by configuration data 424 stored in the television receiver 450. The configuration data may define how the sensor data is collected, how often, what periods of time, what accuracy is required, and other characteristics. The configuration data may specify specific sensor and/or control unit settings for a monitoring and/or control application. The configuration data may define how the sensor readings are processed and/or analyzed. For example, for some applications, sensor analysis may include collecting sensor readings and performing time based analysis to determine trends, such as temperature fluctuations in a typical day or energy usage. Such trending information may be developed by the receiver into charts or graphs for display to the user. For other applications, sensor analysis may include monitoring sensor readings to determine if a threshold value of one or more sensors has been reached.

The function of the system may be determined by loading and/or identifying configuration data for an application. In embodiments, the system 400 may be configured for more than one monitoring or control operation by selecting or loading the appropriate configuration data. In some embodiments the same sensors and/or control units may be used for multiple applications depending on the configuration data used to process and analyze sensor readings and/or activate the control units. Multiple monitoring and/or control applications may be active simultaneously or in a time multiplexed manner using the same or similar set of sensors and/or control units.

For example, the system 400 may be configured for both exercise monitoring and temperature monitoring applications using the same set of sensors. In embodiments, both monitoring applications may be active simultaneously or in a time multiplexed manner depending on which configuration data is loaded. In both monitoring applications the same sensors, such as proximity sensors, or cameras may be used. Using the same sensors, the system may be configured for space temperature monitoring. For temperature monitoring, the system may only monitor a specific subset of the sensors for activity. For temperature monitoring, sensor activity may not need to be saved or recorded. The sensor readings may be monitored for specific thresholds which may indicate a threshold temperature for adjusting the space temperature. In this example, the two different monitoring examples may be selected based on the active configuration data. When one configuration data is active, data from the sensors may be saved and analyzed. When the second configuration data is active, the system may monitor sensor readings for specific thresholds. Of course, multiple or alternative sensors may be used as well.

In embodiments the results, status, analysis, and configuration data details for each application may be communicated to a user. In embodiments auditory, visual, and tactile communication methods may be used. In some cases a display device such as a television may be used for display and audio purposes. The display device may show information related to the monitoring and control application. Statistics, status, configuration data, and other elements may be shown. Users may also save particular configuration data for devices, such as notification suspensions while the user is using the coupled display. A user may log in or be recognized by the system upon activation and the system may make adjustments based on predetermined or recorded configuration data. For example, a user may have instructed that when he is recognized by the system, either automatically or with provided login information, a notification suspension profile personal to the user be enacted. That profile may include that the user would like to continue to receive alarms, such as smoke, fire, or hazard alarms, but that received telephone call information is suspended. The user may access the profile and select to begin, the user may be recognized by the system, or a combination such as being recognized by the system such that the television operations are performed or are input by a remote control, while the user himself selects a particular activity to perform with the system.

Any number of additional adjustments or operations may be performed as well, as would be understood as encompassed by the present technology. For example, the space temperature may be monitored or adjusted as well. In one situation, after the user has been exercising for a period of time, generated heat may raise the space temperature above a threshold such that the home automation engine 211 additionally begins operation or adjustment of the HVAC system to cool the space. Additionally, configuration data for the user may include reducing the space temperature to a particular degree based on a preference of the user. Thus, when the user loads a profile or begins exercising, the home automation system may automatically begin adjusting the space temperature as well in anticipation of heat generation or user preferences.

In embodiments the system may include additional notification and display devices 461 capable of notifying the user, showing the status, configuration data, and/or the like. The additional notification and display devices may be devices that are directly or indirectly connected with the television receiver. In some embodiments computers, mobile devices, phones, tablets, and the like may receive information, notifications, control signals, etc., from the television receiver. Data related to the monitoring and control applications and activity may be transmitted to remote devices and displayed to a user. Such display devices may be used for presenting to the user interfaces that may be used to further configure or change configuration data for each application. An interface may include one or more options, selection tools, navigation tools for modifying the configuration data which in turn may change monitoring and/or control activity of an application. Modification to a configuration may be used to adjust general parameters of a monitoring application to specific constraints or characteristics of a home, user's schedule, control units, and/or the like.

Display interfaces may be used to select and/or download new configurations for monitoring and/or control applications. A catalog of pre-defined configuration data definitions for monitoring and control applications may be available to a user. A user may select, load, and/or install the applications on the television receiver by making a selection using in part the display device. For example, a user may load a profile based on notification suspension preferences as discussed above. In embodiments, configuration data may be a separate executable application, code, package, and/or the like. In some cases, the configuration data may be a set of parameters that define computations, schedules, or options for other processor executable code or instructions. Configuration data may be a meta data, text data, binary file, and/or the like.

In embodiments notification and display devices may be configured to receive periodic, scheduled, or continuous updates for one or more monitoring and control applications. The notifications may be configured to generate pop-up screens, notification banners, sounds, and/or other visual, auditory, and/or tactile alerts. In the case where the display device is a television, some notifications may be configured to cause a pop-up or banner to appear over the programming or content being displayed, such as when a proximity monitor has been triggered in the home. Such an alert may be presented in a centrally located box or in a position different from the fitness information to make it more recognizable. Additionally the program being watched can be paused automatically while such an alert is being presented, and may not be resumed unless receiving an input or acceptance from the user. Some notifications may be configured to cause the television to turn on if it is powered off or in stand-by mode and display relevant information for a user. In this way, users can be warned of activity occurring elsewhere in the system.

The television receiver may also be configured to receive broadcast or other input 462. Such input may include television channels or other information previously described that is used in conjunction with the monitoring system to produce customizable outputs. For example, a user may wish to watch a particular television channel while also receiving video information of activities occurring on the property. The television receiver may receive both the exterior camera information and television channel information to develop a modified output for display. The display may include a split screen in some way, a banner, an overlay, etc.

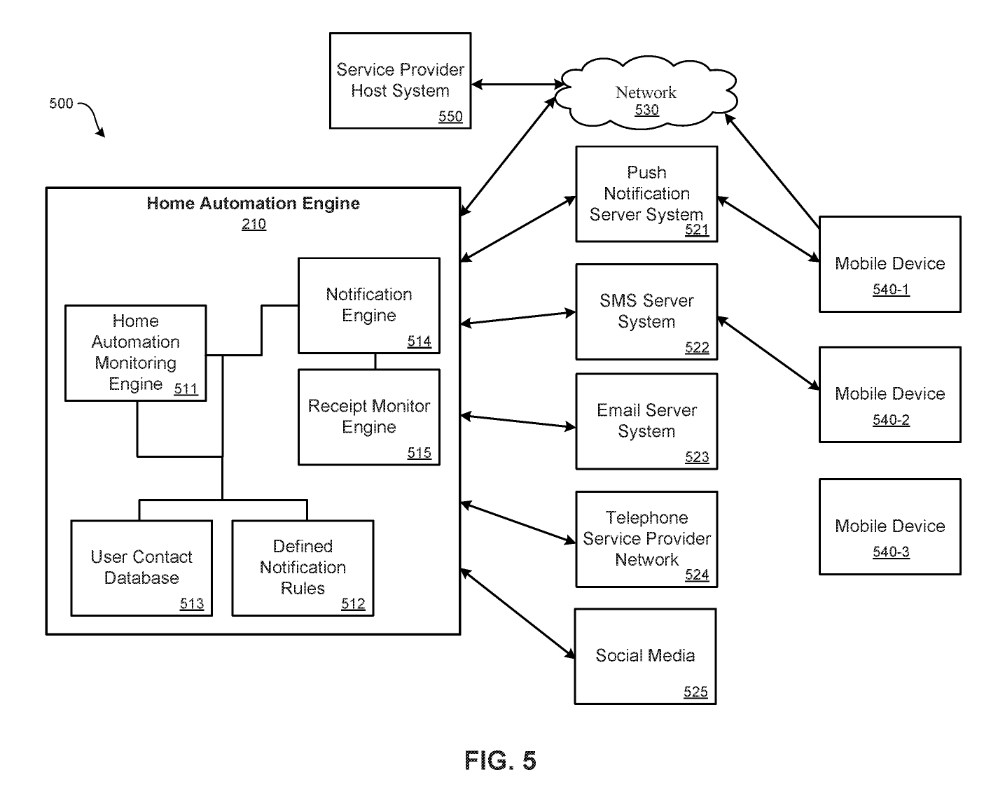

FIG. 5 illustrates an embodiment 500 of a home automation engine using various communication paths to communicate with one or more mobile devices. Embodiment 500 may include: home automation engine 210, push notification server system 521, SMS server system 522, email server system 523, telephone service provider network 524, social media 525, network 530, and mobile devices 540 (540-1, 540-2, 540-3).

Home automation engine 210 may represent hardware, firmware, and/or software that are incorporated as part of the home automation host system, such as television receiver 350, communication device 352, or overlay device 351 of FIG. 3. Home automation engine 210 may include multiple components, which may be implemented using hardware, firmware, and/or software executed by underlying computerized hardware. Home automation engine 210 may include: home automation monitoring engine 511, defined notification rules 512, user contact database 513, notification engine 514, and receipt monitor engine 515.

Home automation monitoring engine 511 may be configured to monitor various home automation devices for events, status updates, and/or other occurrences. Home automation monitoring engine 511 may monitor information that is pushed to home automation engine 210 from various home automation devices. Home automation monitoring engine 511 may additionally or alternatively query various home automation devices for information. Defined notification rules 512 may represent a storage arrangement of rules that were configured by a user. Such defined notification rules may indicate various states, events, and/or other occurrences on which the user desires notifications to be sent to one or more users. Defined notification rules 512, which may be stored using one or more non-transitory computer readable mediums, may allow a user to define or select a particular home automation device, an event or state of the device, a user or group of users, and/or classification of the home automation state or event. For example, Table 1 presents three examples of defined notification rules which may be stored as part of defined notification rules 512. In some embodiments, it may be possible that the service provider provides home automation engine 210 with one or more default defined home automation notification rules. A user may enable or disable such default defined notification rules and/or may be permitted to create customized notification rules for storage among defined notification rules 512. A user may be permitted to enable and disable such defined notification rules as desired.

TABLE 1

| | | | | | | Second |
|---|---|---|---|---|---|---|
| | Home | | | | | (fallback) |
| | Automation | Rule | | | First group of | group of |
| Rule Name | Device | Trigger | Action | Classification | users to notify | users to notify |
| “Person at | Doorbell | Doorbell | Send | Class 1 | Defined | Default |
| Door” | Sensor | actuation | Notification | | community 1 | |
| | | event | [Text of | | | |
| | | | Notification] | | | |
| | | | [Coded | | | |
| | | | Notification] | | | |
| “Window | Window | [Window | Send | Class 2 | Custom: | None |
| Open?” | Sensor | state] = | Notification | | Thomas, Jeff, | |
| | | open | [Text of | | Jason, Andrew | |
| | | | Notification] | | | |
| | | | [Coded | | | |
| | | | Notification] | | | |
| “Door Left | Door | [Door | Send | Urgent | Defined | Defined |
| Ajar” | Sensor | state] = | Notification | | communities | Community 4 |
| | | open >30 | [Text of | | 1 and 3 | |
| | | seconds | Notification] | | | |
| | | | [Coded | | | |
| | | | Notification] | | | |

In Table 1, a user (or service provider) has defined a rule name, the relevant home automation device, the trigger that causes the rule to be invoked, the action to be performed in response to the rule being triggered, the classification of the rule, a first group of users to send the notification, and a second group of users to notify if communication with the first group of users fails. To create a rule, home automation engine 210 may output a user interface that walks a user through creation of the rule such as by presenting the user with various selections. As an example, a user may first type in a name for rule. Next, the user may be presented with a list of home automation devices that are present in the home automation network with which home automation engine 210 is in communication. The user may then be permitted to select among triggers that are applicable to the selected home automation device, such as events and states that can occur at the selected home automation device. For instance, home automation devices such as a doorbell sensor may only have a single possible event: a doorbell actuation. However, in other home automation devices, such as garage door controller 128 may have multiple states, such as open, shut, and ajar. Another possible state or event may be a low battery state or event. Next, the user may select the action that the home automation engine is to perform in response to the trigger event for the home automation device occurring. For the three examples of Table 1, notifications are to be sent to various groups (called “communities”) of users.

In some embodiments, a user may be permitted to select a classification for each rule. The classification may designate the urgency of the rule. Depending on the classification, the communication channels tried for communication with the user and/or the amount of time for which home automation engine 210 waits for a response before trying another communication channel may be controlled. The user may also define one or more groups of users that are to receive the notifications. The first group of users may include one or more users and may indicate which users are to initially receive a notification. The second group of users may remain undefined for a particular rule or may specify one or more users that are to receive the notification if the notification failed to be received by one, more than one, or all users indicated as part of the first group of users.

If a particular grouping of users is to collectively receive notifications, a user may be permitted to define a “community” rather than specifying each user individually. For instance, a user may select from among available users to create “defined community 1,” which may include users such as: “Thomas,” “Nick,” and “Mary.” By specifying “defined community 1” the user may not have to individually select these three users in association with the rule. Such a use of defined communities is exemplified in Table 1.

User contact database 513 may specify definitions of groups of users and orderings of communication paths for individual users and/or classifications. Table 2 presents an exemplary embodiment of an ordering of communication paths for particular user.

TABLE 2

| | First | Second | Third | Fourth |
|---|---|---|---|---|
| | Commu- | Commu- | Commu- | Commu- |
| | nication | nication | nication | nication |
| User Name | Path | Path | Path | Path |
| Andrew | Push | SMS Text | Email (Fail) | Social Media |
| | Notification | Message | | Post (Fail) |
| Jeff | SMS Text | Push | Voice call | Email (fail) |
| | Message | Notification | | |
| Jason | Push | SMS Text | Email (Fail) | — |
| | Notification | | | |
| Thomas | SMS Text | Voice Call | — | — |

For each user, one or more communication paths are defined. For example, for the user named Andrew, the first communication path is a push notification. His second communication Path is an SMS text message. The SMS text message may be used as the communication path if a receipt response is not received in response to transmission of a push notification within a defined period of time. Similarly, if the second communication path fails to yield a receipt being received by receipt monitor engine 515 after a predefined period of time, an email, which is Andrew's third communication path, may be used to send the notification. Entries in Table 2 labeled as “Fail” may be indicative of a communication path that may receive the notification but from which a receipt is not expected and is treated as a failed communication attempt. For instance, an email sent to an email address associated with Andrew may go through and may be accessible by Andrew the next time he accesses his email account; however, notification engine 514 may send the notification via the fourth communication path without waiting a defined period of time since a receipt is not expected to be received in response to the email. For different users, different communication paths may be ordered differently. For instance, an SMS text message is defined as Jeff's first communication path while an SMS text message is defined as Andrew's second communication path. Each user via an application on his or her mobile device, or by directly interacting with the home automation host system executing home automation engine 210, may customize which communication paths are used for their notifications and the ordering of such communication paths.

For each type of communication path, a default period of time to wait for a receipt response may be defined. For instance, for push notifications, a default wait period of time may be one minute, while the default wait period of time for an SMS text message may be two minutes. Such wait periods of time may be tied to the classification of the rule. For instance, a classification of urgent may cause the period of time to be halved. In some embodiments, a user can customize his wait periods of time. For users, various alternate orderings of communication paths may be created based on the classification of the rule and/or whether the user is part of the first group of users or the second, fallback group of users.

When home automation monitoring engine 511 determines that a rule of defined notification rules 512 has been triggered, notification engine 514, by accessing user contact database 513, may begin transmitting one or more notifications to one or more users using one or more communication paths. Notification engine 514 may be configured to try communicating with the user via a first communication path, then waiting a defined period of time to determine if a receipt is received in response notification. If not, notification engine 514 may use user contact database 513 to determine the next communication path for use in communicating with the user. Notification engine 514 may then use such a communication path to try to communicate with the user. Notification engine 514 may determine when communication with a particular user has failed and, if available, a second group of users, which can be referred to as a fallback group of users, should receive a notification instead. In such an instance, notification engine 514 may then use user contact database 513 in order to communicate with the second group of users via the ordering of defined communication paths.

While notification engine 514 may cause notifications to be transmitted to users via various communication paths, receipt monitor engine 515 may monitor for received receipts that are indicative of delivery of the notification. Receipt monitor engine 515 may inform notification engine 514 when a notification has been received and further notifications to that user are unnecessary. Receipt monitor engine 515 may cause information to be stored by home automation engine 210 indicative of the circumstances under which the notification was received. For instance, receipt monitor engine 515 may create a database entry that is indicative of the user, the time of receipt (or of viewing by the user), and the communication path that was successful in causing the notification to reach the user.

Illustrated in embodiment 500 are various communication paths that may be used by notification engine 514 for communicating with various users' mobile devices. These communication paths include: push notification server system 521, SMS server system 522, email server system 523, telephone service provider network 524, social media 525, and network 530. Push notification server system 521 may be a system that causes a mobile device to display a message such that the message must be actively dismissed by the user prior to or otherwise interacting with the mobile device. As such, a push notification has a high likelihood of being viewed by user since the user is required to dismiss the push notification before performing any other functions, home automation related or not, with the mobile device.

SMS server system 522 may cause text messages to be sent to mobile devices. Typically, a mobile device provides an alert, such as a sound of flashing light or vibration to user to indicate that a new text message has been received. However, it is possible for a user to interact with a mobile device that has received a new SMS text message without viewing or otherwise interacting with the text message. Other forms of messaging systems may additionally or alternatively be used, such as Apple's iMessage service. Email server system 523 may serve as an email service provider for user. An email transmitted to a user, that is sent to email server system 523 may be viewed by the user the next time the user accesses email server system 523. In some embodiments, emails are actively pushed by email server system 523 to an application being executed by a user's mobile device, thus increasing the likelihood that a user will look at the email shortly after it has been sent. In other embodiments, a user's mobile device may be required to be triggered by the user to retrieve emails from email server system 523, such as by executing an application associated with the email server system or by logging in to the user's email account via a web browser being executed by the mobile device.

Telephone service provider network 524 may permit voice calls to be performed to a mobile device. A user operating such a mobile device may answer a telephone call to hear a recorded message that is transmitted by notification engine 514 or, if the user does not answer, a voicemail may be left for the user using telephone service provider network 524. Social media 525 may represent various social media networks through which notification engine 514 can try to communicate with the user. Social media may for example include: Twitter®, Facebook®, Tumblr®, LinkedIn®, and/or various other social networking websites. Notification engine 514 may directly transmit a message to a user via social media 525 (e.g., Facebook® Messenger) or may create a post to one or more social media websites via a shared or dedicated social media account that could be viewed by the user. For example, notification engine 514 may have login credentials to a Twitter® account that can be used to post a message indicative of the home automation notification. If the user is following the Twitter® account associated with the notification engine, the notification would be listed in the user's Twitter® feed. If such posts are public (that is, available to be viewed by members of the public, such as on Twitter®), the social media post may be “coded” such that it would only make sense to the user. A user, by configuring an alternate notification text at home automation engine 210 (as indicated in Table 1) may assign coded words or phrases to various home automation events that would be posted to public social media. For instance the door being left ajar may be assigned: “The cat is out of the bag” is a coded message to be posted to social media, while a direct message (e.g., SMS text message) would not be coded, such as: “Your home's front door is ajar.” While to a member of the public, a coded notification may be nonsensical, to the user who configured the notification, the coded notification may be quickly interpreted as meaning his home's front door has been left ajar.

Network 530 may represent one or more public and/or private networks through which notification engine 514 and receipt monitor engine 515 may communicate with a mobile device. For instance network 530 may represent a home wireless network, such as network 170, and/or the Internet. For instance, if notification engine 514 has an IP address of mobile device 540-1, it may be possible for notification engine 514 to directly transmit a notification via network 530 to mobile device 540-1. Additionally or alternatively, mobile device 540-1 may be executing an application that can communicate directly with home automation engine 210 via network 530. Home automation engine 210 and a mobile device may alternatively or additionally communicate with service provider host system 550, which is accessible via network 530, and serves as an intermediary for communications between home automation engine 210 and mobile device. For instance, a message to be transmitted from mobile device 540-1 to home automation engine 210 may be transmitted by mobile device 540-1 to service provider host system 550 via network 530. Home automation engine 210 may periodically query service provider host system 550 via network 530 to determine if any messages are pending for home automation engine 210. In response to such a query, the message transmitted by mobile device 540-1 destined for home automation engine 210 may be retrieved by home automation engine 210.

Three mobile devices are illustrated in embodiment 500. Each of such mobile devices may be associated with a different user. In embodiment 500, such mobile devices are shown as only being available via specific communication paths. This is for example purposes only. For instance, mobile device 540-1 can communicate with home automation engine 210 via push notification server system 521 (which may be unidirectional to mobile device 540-1), and network 530 (such as via communications coordinated by service provider host system 550). Mobile device 540-2 may, for some reason, be unable to receive push notifications sent via push notification server system 521 but may be able to send and receive SMS texts via SMS server system 522. Mobile device 540-3 may be currently unavailable via any of the illustrated communication paths. For example, based on where mobile device 540-3 is located, it may be unable to communicate with a wireless network that enables access to one or more of the communication paths illustrated in FIG. 5 or the mobile device may be turned off.

It should be understood that the communication paths, components of home automation engine 210, and the number of mobile devices 540 are intended to represent examples. For instance, notifications may be sent to types of devices other than mobile devices. For instance, for a user, while the first notification may be sent to the user's mobile device, a second communication path may communicate with the user's desktop computer. Further various components of home automation engine 210 may be divided out into a greater number of components or may be combined into fewer components.

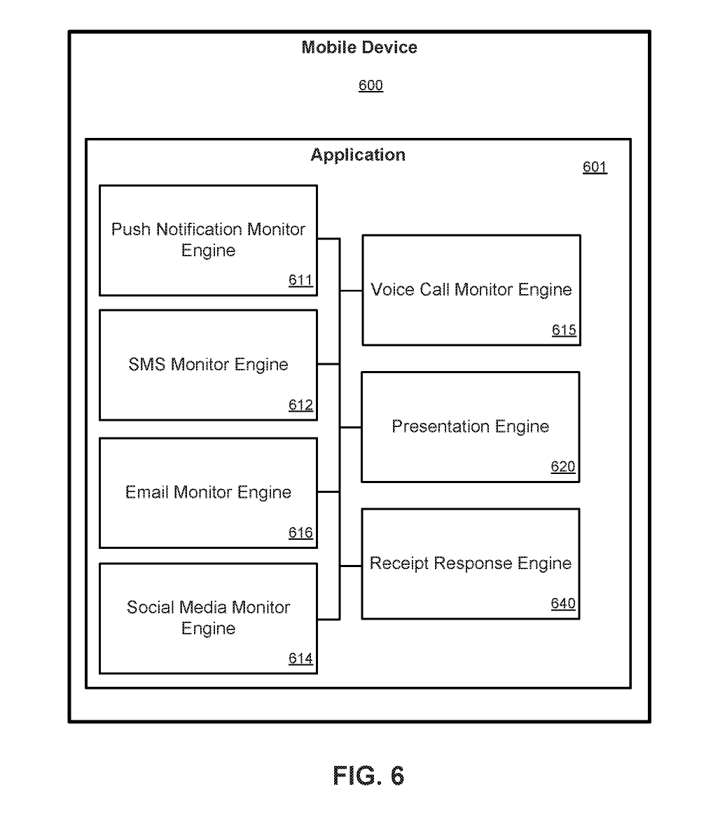

FIG. 6 illustrates an embodiment of a mobile device 600 executing an application that monitors various communication paths. Mobile device 600 may represent each of mobile devices 540 or some other form of mobile device that is receiving notifications from a home automation engine via various possible communication paths. Mobile device 600, which may be a cellular phone, smart phone, smart television, smart watch, smart glasses, table computer, laptop, in-dash network-enabled navigation system, or other form of a wireless and/or mobile computerized device, may execute application 601. Application 601 may be executed in the background such that when a user is not interacting with application 601, a process of application 601 can monitor various communication paths of mobile device 600. A user may also bring application 601 to the foreground, such that the user can view a user interface of application 601 and generally interact with application 601. Application 601 may include: push notification monitor engine 611, SMS monitor engine 612, email monitor engine 613, social media monitor engine 614, presentation engine 620, and receipt response engine 640. Such modules may be implemented using software that is executed on underlying hardware.

Push notification monitor engine 611 may monitor for when a push notification is received by mobile device 600 that includes a notification from notification engine 514 of home automation engine 210. The operating system of mobile device 600 may cause the push notification to be presented by a display of mobile device 600 such that a user is required to view and dismiss the push notification before performing any other function on mobile device 600. The push notification, when displayed, may present text of the push notification indicative of the home automation event. For instance, returning to Table 1 for the “Person at Door” event, the corresponding [Text of Notification] from the event may be presented as part of the push notification. Additional information may include the time at which the event occurred and a location of the home automation engine (which may be useful if the user has home automation systems installed at multiple locations, such as a primary home, office building, and vacation home). Push notification monitor engine 611 may determine 1) that the push notification has been received by mobile device 600; and 2) if the user has dismissed the push notification.

SMS monitor engine 612 may monitor for when a text message is received by mobile device 600 that includes a notification from notification engine 514 of home automation engine 210. SMS monitor engine 612 may monitor for a particular string of characters that is indicative of the home automation engine 210 or the source number from which the SMS text message may be indicative of the home automation engine. The operating system of mobile device 600 may cause the text message to be stored and may cause the mobile device 600 to output vibration, sound, and/or light indicative of the received text message. The user may need to select the text message for presentation or the text message may be automatically displayed by mobile device 600. The text of the SMS message may present text indicative of the home automation event. For instance, as with the push message, returning to Table 1 for the “Person at Door” event, the corresponding [Text of Notification] from the event may be presented as part of the SMS message. Additional information may include the time at which the event occurred and a location of the home automation engine. SMS monitor engine 612 may determine 1) that the SMS message containing the notification has been received by mobile device 600; and 2) if the user has viewed the SMS text containing the notification.

Email monitor engine 613 may monitor for when an email is received by mobile device 600 that includes a notification from notification engine 514 of home automation engine 210. Email monitor engine 613 may monitor for a particular string of characters in either the body or subject line of the email that is indicative of the home automation engine 210 or the sender from which the email was received may be indicative of the home automation engine. The email may be added to an inbox of mobile device 600 and an operating system of mobile device 600 may cause vibration, sound, and/or light to be output that is indicative of the received email. The user may need to select an email application and the email for the email to be presented by mobile device 600. The text of the email may present text indicative of the home automation event. For instance, as with the push message and the SMS text message, returning to Table 1 for the “Person at Door” event, the corresponding [Text of Notification] from the event may be presented as part of the SMS message. Additional information may include the time at which the event occurred and a location of the home automation engine. Since an email can contain significantly more information than an SMS text or push notification, more details regarding the home automation event and system may be presented as part of the email. Email monitor engine 613 may determine 1) that the email message containing the notification has been received by mobile device 600; and 2) if the user has opened the email containing the notification.

Social media monitor engine 614 may monitor for when a social media post is made by home automation engine 210 that is indicative of a notification. As such, social media monitor engine 614 may periodically check one or more social media feeds for posts either privately sent to a user of mobile device 600 or publically posted. Social media monitor engine 614 may monitor for a particular string of characters that is indicative of the home automation engine 210 or the username or account from which the post was made which is indicative of the home automation engine. The text of the social media post may present text indicative of the home automation event. For instance, as with the push message, returning to Table 1 for the “Person at Door” event, the corresponding [Text of Notification] from the event may be presented as part of the social media post. If the post is made publically, a code message may be posted instead of the [Text of Notification]. For instance, referring to Table 1, [Coded Notification] may be publically posted instead of [Text of Notification]. Additional information posted may include the time at which the event occurred and a location of the home automation engine. Social media monitor engine 614 may determine 1) mobile device 600 has received the social media post (e.g., in an updated Twitter® feed); and 2) if the user has viewed the social media message containing the notification or the social media feed containing the notification.

Voice call monitor engine 615 may monitor for when a voice call or voicemail is received by mobile device 600 that includes a notification from notification engine 514 of home automation engine 210. Voice call monitor engine 615 may monitor for a particular phone number from which the call is originating to determine that a notification from the home automation engine has been received. The operating system of mobile device 600 may cause an indication of the voice message to be presented via output vibration, sound, and/or light. The user may need to answer the call or listen to the voicemail in order to receive the notification. Voice call monitor engine 615 may determine 1) whether the notification has been received; and 2) if the user has listened to the voicemail or answered the call. The voice call or voicemail may include synthesized voice that reads the notification for the home automation event. Additional information may include the time at which the event occurred and a location of the home automation engine.

In some embodiments, it may not be possible to monitor various communication paths. For instance, a user may have his email only accessible via a specialized application (e.g., Google's® Gmail™ application). As such, the user may receive the email; however, email monitor engine 613 may not be able to determine that the email has been received. During an initial configuration, home automation engine 210 may test communication paths with application 601 when it is known or expected that such communication paths are functional. Such a test may determine which communication paths of application 601 will be able to acknowledge receipt of notifications. When a notification cannot be acknowledged, notification engine 514 may still use such a communication path to send a notification but may assume transmission has failed and/or may only use such a communication path as a final attempt. For instance, such communication paths are noted in Table 2 with the “(fail)” designation.

A user may view the push notifications, SMS texts, emails, social media posts and/or messages, and (listen to) voice calls directly. Additionally, when one of the monitor engines (611-615) notes that a notification has been received, presentation engine 620 may be triggered to present an additional or alternate indication of the notification. For instance, if the user launches application 601 (such that it is displayed and no longer only executed in the background of mobile device 600), presentation engine 620 may cause information regarding the notification to be presented in a user friendly format and may allow the user to perform various actions in response to the notification. For instance, if the notification is “Door left ajar,” the user may have the ability to select from “View security camera feed,” “Call at-home User” (which may determine, such as based on geo-positioning, a user who is within the home) and “Call 911.”

Receipt response engine 640 may receive information from engines 611-615 that is indicative of a notification being received and/or of the notification being viewed, dismissed, or heard by the user. Receipt response engine 640 may generate and cause a response to be transmitted by mobile device 600 to receipt monitor engine 515 of home automation engine 210. The receipt response may indicate the time at which the notification was received and/or viewed/heard by the user.

A specific embodiment includes a television receiver that transmits the audio portion of a media program to a wireless headset worn by a user. The television receiver is configured to receive user input indicating that after a particular media program or at a particular time, the television receiver should transmit a command to the wireless headset that causes the wireless headset to turn off. Thus, when a particular media program has ended, or when a particular time has arrived, the television receiver transmits a command to the wireless headset causing the wireless headset to turn off. In this way, if a user intends to watch a media program and plans to fall asleep during the program or plans to go to bed after the program, the wireless headset will not needlessly consume batteries long after the user has stopped using the wireless headset.

A specific embodiment includes a wireless headset that is configured to receive the audio portion of the media program from a television receiver or another media device. The wireless headset includes a sensor that monitors a physical trait of the user. If the physical trait of the user indicates that the user has fallen asleep, then the wireless headset turns off. In one embodiment the sensor includes an inertial sensor that detects the movements of the user's head. If the movements of the user's head indicates that the user is asleep, then the wireless headset turns off. Alternatively, the inertial sensor can detect the orientation of the user's head, for example whether the user's head is upright or tilted to one side. If the orientation of the user's head indicates that the user is asleep, then the wireless headset turns off.

In a specific embodiment, the monitoring and sending of commands is done by the television receiver or other media device that is configured to transmit an audio portion of the media program to the wireless headset.

In a specific embodiment, the sensor includes a camera that monitors the user's eyes to see if they are closed for a prolonged period of time. In one embodiment the camera monitors the orientation of the user's head to detect if the orientation of the user's head indicates that the user has fallen asleep.

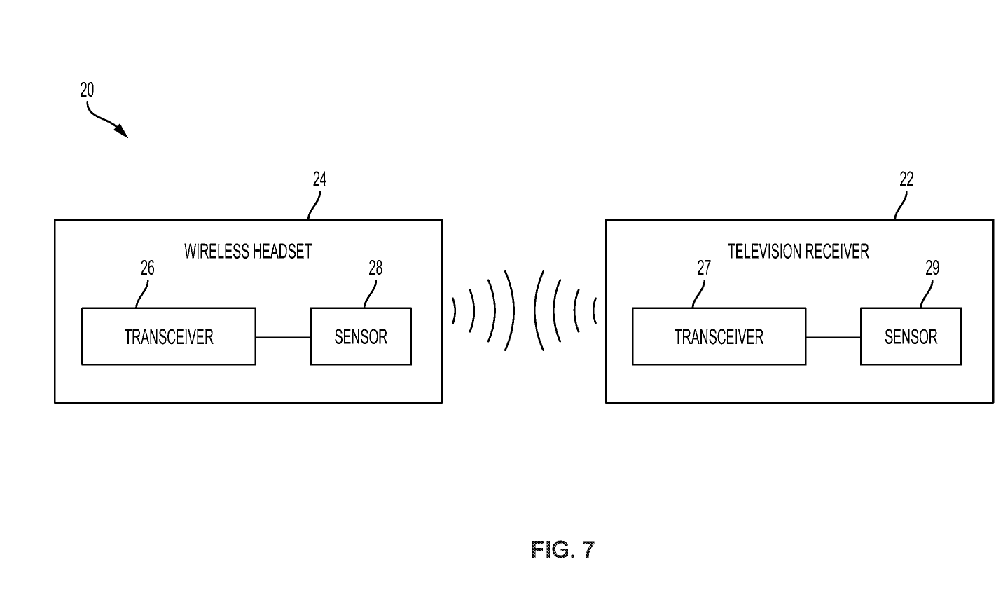

FIG. 7 is a block diagram of a system 20 including a television receiver 22 and a wireless headset 24. The wireless headset 24 includes a transceiver 26 and a sensor 28.

The television receiver 22 receives media content from a television programming distributor such as a cable television distributor, satellite television distributor, an Internet television distributor, or a terrestrial broadcast television distributor. The media content includes media programs such as television programs, movies, pay-per-view movies, radio programs, or other types of media content.

The television receiver 22 typically displays the video portion of a media program on a display coupled to the television receiver 22. The television receiver 22 outputs an audio portion of the media program to the wireless headset 24 worn by a user. In particular, the television receiver 22 wirelessly transmits a signal including the audio portion of the media program to the wireless headset 24. The transceiver 26 of a wireless headset 24 receives the signal from the television receiver 22 and outputs the audio portion of the media program to headphones of the wireless headset 24.

The wireless headset 24 will typically be powered by batteries. If the batteries become depleted, the wireless headset 24 will become inoperable until the batteries are replaced or recharged. The transceiver 26 of the wireless headset 24 consumes a relatively large amount of energy when it is receiving the audio portion of a media program. To avoid the inconvenience of having to frequently replace rechargeable batteries of the wireless headset 24, the system 20 of FIG. 7 includes functionality designed to reduce the amount of power consumed by the wireless headset, particularly when the user is no longer using the wireless headset or has fallen asleep.

In one embodiment, the television receiver 22 includes an electronic programming guide which can be accessed by the user to view which media programs are available on particular channels at particular times. By operating a remote control, or by utilizing inputs coupled directly to the television receiver 22, the user can access the electronic programming guide and can select a media program to view. When the user selects a media program to view, the user can also enter input directing the television receiver to send a command to the wireless headset 24 to turn off at the end of the selected media program. At the end of the media program, the television receiver 22 will transmit a wireless command signal to the wireless headset 24 directing the wireless headset 24 to enter a reduced power state or to turn off entirely.

This can be of particular use when the user anticipates that he will stop using the wireless headset 24 at the end of the selected media program, or if the user anticipates that he may fall asleep during the media program. In many cases a user plans to stop using the wireless headset at the end of the selected media program, but forgets to turn off the wireless headset 24 or the television receiver 22. This is particularly common in an instance in which the user turns off a television coupled to the television receiver 22, but fails to turn off the television receiver 22. The television receiver 22 may continue to broadcast the audio portion of a subsequent media program to the wireless headset 24. If the user has also forgotten to turn off the wireless headset 24, the transceiver 26 of the wireless headset 24 will continue to operate and receive the audio portion of the subsequent media program. The continued operation of the transceiver 26 will deplete the batteries of the wireless headset 24 even though the user is no longer using the wireless headset 24. When the user returns at a future time to use the wireless headset 24, he may find that the batteries are entirely depleted. It is both inconvenient and expensive to repeatedly recharge the batteries or purchase new batteries.

However, the functionality of the system 20 allows the user to avoid this situation by enabling the user to choose to turn off the wireless headset 24 at the end of a selected media program. Thus, if the user has scheduled the television receiver 22 to turn off the wireless headset 24 at the end of a selected media program, the television receiver 22 will transmit a command to the wireless headset 24 instructing wireless headset 24 to turn off the transceiver 26 or to shut down altogether. If the user then forgets to turn off the wireless headset 24 or the television receiver 22, the wireless headset 24 will nevertheless stop the function of the transceiver 26. In this way the battery life of the wireless headset 24 is not needlessly wasted.

Alternatively, the user of the wireless headset 24 can instruct the television receiver 22 to turn off the wireless headset 24 at a particular time of day. For instance, the user may plan to relax and channel surf at a later time in the evening, without a plan to view any particular media program. Nevertheless the user believes that he will most likely go to bed by midnight. Or, the user can set his planned schedule to be in bed by midnight. The user can thus instruct the television receiver 22 to turn off the wireless headset 24 at midnight. Thus, if the user has gone to bed or if the user has fallen asleep while watching a media program, at midnight the television receiver 22 will transmit a command to the wireless headset 24 causing the wireless headset 24 to turn off the transceiver 26 or to shut down entirely. The user can store a long term, scheduled program to turn off at selected times each day. In this way, the batteries of the wireless headset 24 can be preserved when the user is no longer viewing the media program.

This functionality can also be used by media devices other than a television receiver 22. For example, the wireless headset may receive the audio portion of a media program from a game console, a computer, a tablet, a stereo system, or other kinds of media devices. The functionality described above with respect to the television receiver 22 can also be implemented in these other media devices.

In one example, a user of the wireless headset may be playing a video game and receiving an audio portion of the videogame, as well as audio communication from other players, through the wireless headset 24. The user can schedule the game console or other device to turn off the wireless headset 24 at a particular time or after the user is no longer playing in a particular game. In this way, the wireless headset 24 does not needlessly deplete the batteries after the user is no longer using the wireless headset 24. Those of skill in the art will recognize, in light of the present disclosure, that the energy-saving functionality can be implemented in many other kinds of devices that communicate with a wireless headset 24. All such other devices fall within the scope of the present disclosure.

In one embodiment, the sensor 28 of the wireless headset 24 detects when the user of the wireless headset 24 has fallen asleep. The sensor 28 monitors a physical state of the user and detects whether the user is awake or asleep based on the monitored physical state of the user. When the sensor 28 detects that the user has fallen asleep, the sensor 28 outputs a signal to control circuitry of the wireless headset 24 causing the wireless headset 24 to turn off the transceiver 26 or to shut down altogether.

In one example, the sensor 28 is an inertial sensor that detects the motion of the user's head. Commonly, when a user is awake, the user's head will make particular shifting movements such as nodding, quickly moving to look another direction then moving back, and many other kinds of movements. In contrast, when the user is asleep, the head moves very little or only makes certain kinds of movements particular to a state of sleep. Based on these movements, the sensor 28 can detect whether the user is awake or asleep. If the motion of the user's head, as detected by the sensor 28, indicates that the user is asleep, the sensor 28 can output a signal causing the wireless headset 24 to turn off the transceiver 26 or to shut down altogether.

Alternatively, the sensor 28 can include a microphone that senses the breathing of the user. The breathing pattern of the user can provide an indication of whether the user is asleep or not. The breathing pattern may also include certain unique sounds, such as snoring or making other loud noises. When a user falls asleep, the user's breathing pattern changes in a known manner. In particular, the frequency of breathing decreases when a user is asleep. The microphone can detect the users breathing pattern and can determine if the user has fallen asleep based on the breathing pattern. If the microphone determines that the user has fallen asleep, based on the users breathing pattern, the microphone can cause the wireless headset 24 to turn off the transceiver 26 or to shut down altogether.

Sensor 28 can also include a pulse rate monitor that is capable of measuring the heart rate of the user. The heart rate of the user can provide an indication of whether the user has fallen asleep. In particular, when the user falls asleep, the heart rate of the user typically decreases to a level that is significantly lower than the heart rate of the user when the user is awake. If the pulse rate monitor detects that the pulse rate has decreased to a level indicative of the user being asleep, the pulse rate monitor can cause the wireless headset 24 to turn off the transceiver 26 or to shut down altogether.

Sensor 28 can also include an accelerometer that determines when the sensor has not moved for a particular period of time. For example, sensor 28 may be located within a mobile phone that the user possesses. Sensor 28 may determine that a user is asleep by determining that the user has not moved the user's phone for an extended period of time. Such a determination may be assisted using data collected by the sensor over time. Such data may indicate that the user almost never goes more than 30 seconds, 1 minute, or a different period of time without moving the user's phone.

Sensor 28 can also include an infrared or other type of sensor that can detect temperature, such as body temperature. For example, if sensor 28 was located within a wearable home automation or other mobile device, such as a smart watch, then the sensor may be able to determine if the user's body temperature has changed. Such an observation may be used to determine if a user is asleep because of the change in body temperature (e.g. a user's body temperature may increase when the user is asleep). The observed temperatures, or changes in temperature, may be compared to certain thresholds. The thresholds may be predetermined, or may dynamically change over time based on observed data over time. For example, the observed temperatures may allow a device to determine the average temperature of a user's body when the user is awake, and the average temperature of the user's body when the user is asleep. Such determined values may be used as the thresholds. Alternatively, these determined values may be used to determine the thresholds. Different thresholds (other than the averages themselves) may be used so that the user passing the threshold(s) allows the device to be more certain that the user is in the user state resulting from that passed threshold.

In one embodiment, when the sensor 28 causes the wireless headset 24 to turn off the radio or to shut down altogether, the wireless headset 24 first transmits a signal to the television receiver 22 indicating that the user is asleep. The television receiver 22 can then enter a low power state while the user is asleep. The low power state can include ceasing transmission of the audio portion to the wireless headset 24 and ceasing transmission of the video portion to the display. The low power state can further include turning off the television receiver 22 altogether. The television receiver 22 can also transfer the shutdown command to the display or to other media devices coupled to the television receiver 22. In this way, when the wireless headset 24 detects that the user has fallen asleep, the wireless headset 24 can also cause other media devices to enter a reduced power state or to shut down altogether, thereby reducing the power consumed by the media devices while the user is asleep.

When the television receiver 22 or other media device receives a signal from the wireless headset 24 indicating that a user is asleep, the television receiver 22 or the media device can take steps to ensure that the user does not miss any portion of the media program that the user is watching. For example, if the user is watching a television program broadcast at a particular time, upon being notified that the user has fallen asleep the television receiver 22 can either pause or automatically record the program to a DVR. The recording can be the remaining portion of the program or going back to record the entire program, which can be done easily since the last few hours of viewed program content are stored in a buffer. In this way, when the user wakes up she can immediately unpause the television program and proceed to watch the remaining portion of the television program or go back to a prior portion that was missed as the user was starting to fall asleep. Alternatively, the user can enter the DVR menu and select to play the remaining portion of the program from among the titles recorded in the DVR. In a similar manner, if the user is watching a movie on DVD or Blu-ray, the DVD or Blu-ray player can immediately cause the DVD or Blu-ray to stop upon being notified by the wireless headset 24 that the user has fallen asleep. Those of skill in the art will recognize that many other actions can be taken by the television receiver or other media devices for the user's convenience upon being notified that the user has fallen asleep.

The sensor 28 can also cause the transceiver 26 of the wireless headset 24 to turn back on when the user wakes up. For example, if the sensor 28 has caused the wireless transceiver 26 to turn off because the sensor 28 has detected that the user has fallen asleep, the sensor 28 can still be in a functioning state and continue to monitor the physical state of the user. If the physical state of the user indicates that the user has woken up, the sensor 28 can cause the transceiver 26 to turn back on and to continue to receive the audio portion of the media program. The wireless headset 24 can also transmit signals to the television receiver 22 or other media devices indicating that the user has woken up. The television receiver 22 or other media devices that have entered a low power mode and/or paused or recorded a media program can immediately resume playing the media program upon notification that the user has woken up. Alternatively, the television receiver 22 or other media device can notify the user that the media program was paused or recorded upon detecting that the user fell asleep. The television receiver 22 or other media device can prompt the user for input regarding whether the user would like to immediately begin playing the paused or recorded program.

In one embodiment, the television receiver 22 includes a sensor 29 that can monitor a physical state of the user. The sensor 29 of the television receiver 22 detects that the user has fallen asleep, the television receiver 22 can transmit a signal via transceiver 27 to the wireless headset 24 indicating that the user has fallen asleep. In response to receiving the signal from the television receiver 22, the wireless headset 24 can enter a low power mode by turning off the transceiver 26 or by shutting down altogether.

In one embodiment, the sensor 29 of the television receiver 22 includes a camera that can monitor the eyes of the user. Sensor 29 can detect if the user's eyes are closed. If the sensor 29 detects that the user's eyes are closed for an extended period of time, then the television receiver 22 determines that the user is asleep. The television receiver 22 then transmits a signal to the wireless headset 24 causing the wireless headset 24 to enter a low power or shutdown mode as described previously. Further details regarding the features of a television receiver 22 or other media device that monitors a user's eyes can be found in U.S. patent application Ser. No. 13/910,804, hereby incorporated by reference in its entirety. Other systems, such as Xbox One and Kinect that are known in the art can also be used.

The television receiver 22 can also monitor and dynamically learn the user's habits/routines and use that information to determine when to automatically power down the wireless headset 24. For example, the television receiver 22 detects that the user commonly watches the evening news and then turns off the television receiver 22 and the wireless headset 24 after the news has ended. On a particular day, the television receiver 22 may detect that the user has not powered down the television receiver 22 and the wireless headset 24 after the conclusion of the evening news. The television receiver can assume that the user might have fallen asleep and that this is the reason for the break from the user's normal routine. The television receiver 22 outputs a prompt on a display indicating that the system 20 will be powered down unless the user provides feedback such as an audible statement command detected by the headset 24 or the television receiver 22, a button press on the wireless headset 24 or on a remote control, etc. If the user does not respond then the wireless headset 24 and the television receiver 22 are powered down.

While many of the features of the system 20 have been described in relation to a television receiver 22 and the wireless headset 24, principles of the present disclosure extend to 3-D glasses or other types of headwear or devices that can be worn by a user in conjunction with viewing media programs. Thus, the 3-D glasses can include the sensor 28 that detects whether the user has fallen asleep and can cause the 3-D glasses to enter into a low power state. Likewise, the television receiver 22 or other media device can transmit a signal to the 3-D glasses causing the 3-D glasses to enter a low power or shutdown state at the end of a selected media program, at a selected time, or upon detecting that the user has fallen asleep.

While a wireless headset 24 has been shown to include a single transceiver 26, those of skill in the art will understand that the wireless headset 24 can include multiple wireless receivers and transmitters. Upon detecting that a user is asleep, the wireless headset 24 may shutdown one or more of the wireless receivers and transmitters while leaving other wireless receivers and transmitters still functioning. For example, in one embodiment the transceiver 26 includes a Bluetooth transceiver that receives the audio portion of the media program. The Bluetooth transceiver can be shutdown when the user falls asleep while other transceivers may still be active. Many configurations of the transceiver 26 are apparent in light of the present disclosure. All such configurations fall within the scope of the present disclosure.

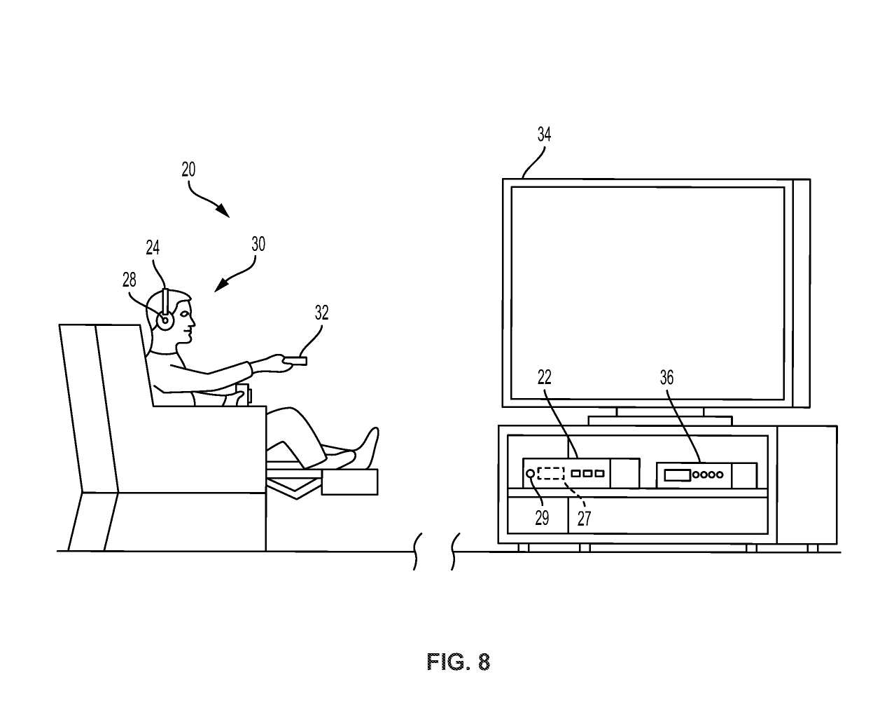

FIG. 8 is an illustration of a residential setting including a media presentation system 20 according to one embodiment. The media presentation system 20 includes a television receiver 22, the wireless headset 24 worn by a user 30, a remote control 32 held by the user 30, a television 34 coupled to the television receiver 22, and an electronic media device 36 coupled to the television receiver 22 and the television 34. The wireless headset 24 includes a transceiver 26 and a sensor 28. The television receiver 22 includes a transceiver 27 and a sensor 29.

In one embodiment, the television receiver 22 receives media content from a satellite television service provider, cable television provider, the Internet, terrestrial broadcast signals, etc. The television receiver 22 displays media programs on the television 34. The user 30 can operate a remote control 32 to control the television receiver 22. The user 30 can select media programs to be displayed on a television 34 by the television receiver 22. The audio portion of the media programs are transmitted from the transceiver 27 to the wireless headset 24. The user 30 hears the audio portion of the media program via the headphones of the wireless headset 24.

By using the remote control 32, the user 30 can access menu screens of the television receiver 22. In the menu screens, the user can select a particular media program after which the television receiver 22 should transmit a command to the wireless headset 24 to enter a low power mode or to shut down altogether. For example, the user may wish to watch Sports Center at 10 PM on ESPN. Prior to or during viewing of Sports Center, the user can access the programming guide and can select Sports Center as a final media program to be viewed that night. In this way the user can tell the television receiver 22 to transmit the signal to the wireless headset 24 causing the wireless headset to enter the low power or shutdown mode at the conclusion of the program. In another example, at the end of Sports Center, the television receiver 22 can cease transmitting the audio portion to the wireless headset 24. The wireless headset 24 can preserve power by not actively receiving the audio portion of the broadcast.

Alternatively, from the menu screens of the television receiver 22, the user can select a particular time at which to transmit the signal to the wireless headset 24 causing the wireless headset to enter a reduced power mode or to shut down altogether.

In one example, the user can sit down to the various television programs on the television 34. The user expects to be done watching television by 1 AM. In particular, the user expects either to have fallen asleep while watching television or to have gone to bed by 1 AM. The user therefore accesses the menu screens of the television receiver 22 and designates 1 AM as a time after which the wireless headset should enter a low power mode and/or the audio portion of the media programs should no longer be transmitted to the wireless headset 24 from the television receiver 22. Therefore, at 1 AM the television receiver 22 transmits a signal to the wireless headset 24 causing wireless headset 24 to enter the low power or shutdown state. The television receiver 22 can also turn off or cease transmitting the audio portion of the media program to the wireless headset 24.

In one embodiment, the sensor 28 of the wireless headset 24 monitors a physical state of the user such as head motion, head orientation, pulse, breathing rate, brainwaves, etc. to detect when the user has fallen asleep. If the sensor 28 detects that the user 30 has fallen asleep, then the sensor 28 can cause the wireless headset 24 to enter a low power mode by shutting down the transceiver 26 or a particular portion of the transceiver 26. The sensor 28 can also cause the entire wireless headset 24 to shut down.

In one embodiment, the television receiver 22 includes a sensor 29, to monitor a physical state of the user 30 such as whether the user's eyes are open. If the sensor 29 detects that the user has fallen asleep, then the television receiver 22 can transmit a signal to the wireless headset 24 causing the wireless headset 24 to enter a low power or shutdown mode.

The media device 36 can be a game console, a DVD player, stereo system or other electronic media device that plays media programs that include an audio portion. The media device 36 transmits the audio portion of the media program to the wireless headset 24. The television receiver 22 can be configured to cause the media device 36 to shut down at a particular time or after a particular program has selected by the user 30. The television receiver 22 can also cause the media device 36 to stop transmitting an audio portion of the media program to the wireless headset 24 at the particular time or after the particular media program has ended. Alternatively, the media device 36 can include functionality allowing the user to select a particular time to cease transmission of the audio portion to the wireless headset 24 or to send a signal to the wireless headset 24 causing the wireless headset 24 to enter the low power or shutdown mode as described previously. Those of skill in the art will recognize that many configurations of the electronic device 36 and television receiver 22 are possible in light of the present disclosure. All such other configurations of the electronic device 36 and television receiver 22 fall within the scope of the present disclosure.

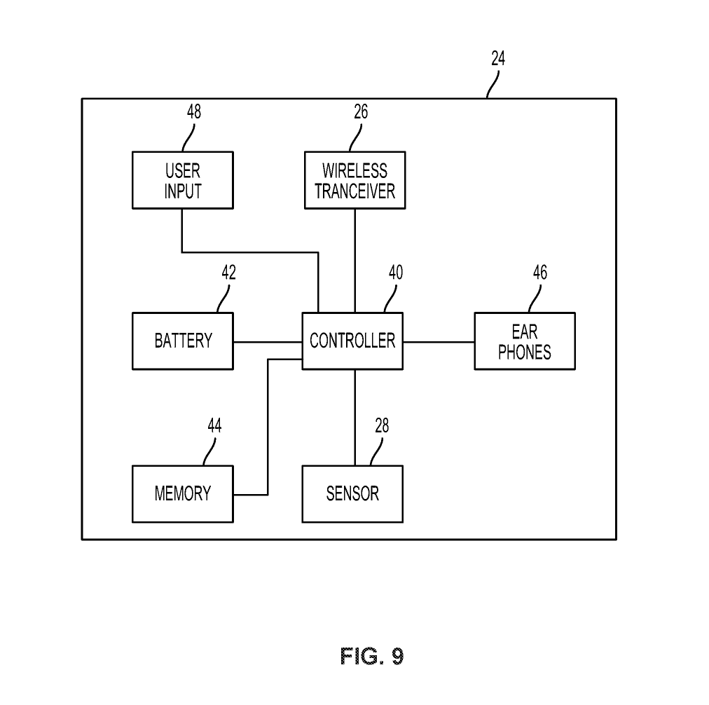

FIG. 9 is a block diagram of a wireless headset 24 according to one embodiment. The wireless headset 24 includes a controller 40. The controller 40 is coupled to a battery 42. The controller 40 is further coupled to a memory 44, earphones 46, user input keys 48, wireless transceiver 26, and the sensor 28.

The memory 44 can include one or more of an EEPROM, ROM, SRAM, DRAM, flash RAM, or other types of memory devices. The controller 40 executes instructions stored in the memory 44 to perform the functions of the wireless headset 24.

The wireless transceiver 26 includes one or more wireless transmitters and receivers by which the wireless headset 24 communicates with other devices. The controller 40 controls the wireless transceiver 26. The wireless transceiver 26 receives the audio portion of the media program from a television receiver 22 or other media device 36 as described previously. In one embodiment, the wireless transceiver 26 includes IR and RF transmitters and receivers including a Bluetooth transceiver that receives the audio portion of the media program from the television receiver 22 or other media device 36. The wireless transceiver 26 can also transmit signals to the television receiver 22 and other electronic media devices 36 indicating that the user 30 has fallen asleep. In this way the wireless transceiver 26 can cause the television receiver 22 or other electronic media devices 36 to pause or record the media program, to enter a low power mode, etc., as described previously.

The earphones 46 include speakers that output the audio portion of the media program as an audible sound to the user 30. In particular, the earphones 46 fit on or inside the ears of the user 30 and output sound to the user 30 received via the wireless transceiver 26.

The user input keys 48 are the inputs by which a user 30 can control the wireless headset 24. User input keys 48 can include on, off, and standby keys, volume control keys, wireless transceiver control keys or any other keys suitable for allowing the user 30 to interact with and control the wireless headset 24.

The user inputs 48 can also be on the remote control for the television receiver 22. The remote control can send signals to the television receiver which will store the program for the headset 24 and then output signals to control it.

The sensor 28 monitors the physical state of the user. The sensor 28 can detect whether the user 30 has fallen asleep based on the physical state monitored by the sensor 28. The sensor 28 can include one or more accelerometers, gyroscopes, microphones, pulse rate monitors, breathing monitors, cameras, or any other suitable device for detecting whether the user 30 has fallen asleep. The controller 40 controls the sensor 28 and receives signals from the sensor 28 indicating the physical state of the user 30. In one embodiment, the controller 40 detects whether or not the user has fallen asleep based on comparing the signals received from the sensor 28 to data stored in the memory 44. If the controller 40 determines that the user has fallen asleep, the controller 40 can cause the wireless transceiver 26 to output a signal to the television receiver 22, the television 34, or any other electronic media devices 36. The controller 40 can shut down the wireless transceiver 26 or a portion of the wireless transceiver 26 based on instructions stored in the memory 44. The controller 40 can also cause the entire wireless headset 24 to shut down. In this way, the sensor 28 and the controller 40 can preserve the life of the battery 42 by shutting down one or more portions of the wireless headset 24 when the sensor 28 indicates that the user 30 has fallen asleep. The controller 40 can also cause the wireless transceiver 26 or other components of the wireless headset 24 to wake up and resume full functionality when the sensor 28 indicates that the user has woken up.

Those of skill in the art will understand that the wireless headset 24 can include many more or fewer components than those disclosed in the block diagram of FIG. 9 depending on the particular specification and design of the wireless headset 24 in accordance with principles of the present disclosure. All other configurations of the wireless headset 24 fall within the scope of the present disclosure.

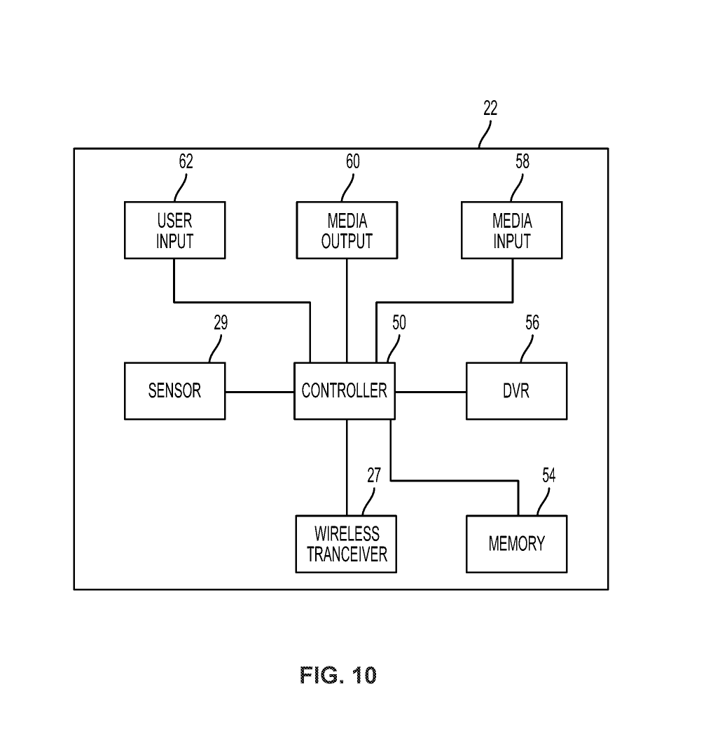

FIG. 10 is a block diagram of a television receiver 22 according to one embodiment. The television receiver 22 includes a controller 50 coupled to a media input 58. Controller 50 is also coupled to a media output 60, user input 62, sensor 29, a wireless transceiver 27, a memory 54, and a DVR 56.

The media input 58 receives media program data or signals from a satellite television provider, cable television provider, terrestrial broadcast signals, other electronic media devices coupled to the television receiver 22, or any other suitable source of media programs. The media input 58 is controlled by the controller 50.

The media output 60 outputs media programs to a display 34 or other electronic media devices coupled to the television receiver 22 either by a wired connection or a wireless connection. For example, when the television receiver 22 receives a media program from a content provider via the media input 58, the controller 50 processes the input media program and outputs the video portion of the media program to the display 34 via the media output 60.

The digital video recorder (DVR 56) records media programs selected by the user and stores them in memory. In one embodiment, when the television receiver 22 receives a signal from the wireless headset 24 indicating that the user has fallen asleep, the controller 50 causes the DVR 56 to record the remaining portion of the media program currently being viewed.

The memory 54 stores data and software instructions for execution by the controller 50. In particular, the controller 50 controls the various components of the television receiver 22 in accordance with instructions stored in the memory 54 and input received from the user 30.

The wireless transceiver 27 includes one or more wireless receivers and transmitters. The wireless transceiver 27 can include one or more infrared receivers and transmitters, one or more RF receivers and transmitters, a Bluetooth transceiver, etc. In one embodiment, the wireless transceiver 27 transmits to the headset 24 a signal causing the wireless headset 24 to enter a low power or shutdown mode as described previously. The wireless transceiver 27 can also transmit signals to the television 34 or the other electronic media devices 36 causing them to enter a low power or shutdown mode as described previously. The wireless transceiver 27 also receives signals from the remote control 32 by which the user controls the television receiver 22.

The user input 62 can include one or more keys, buttons or other input controls on the face of the television receiver 22. The user input 62 can include keys for allowing the user 30 to manually turn off the television receiver 22, to change the channel of the television receiver 22, or to perform other common input commands for controlling a television receiver 22.

The sensor 29 monitors a physical state of the user 30 while the user is wearing the wireless headset 24. As described previously, if the sensor 29 detects that the user 30 has fallen asleep while viewing a media program the television receiver 22 outputs a signal to the wireless headset 24 causing the wireless headset 24 to enter a low power or shutdown mode. In one embodiment, the sensor 29 includes one or more cameras that track the movements of the user's eyes or head to determine if the user is asleep. The cameras can also detect if the user's eyes are opened and closed. The television receiver 22 can determine if the user is asleep based on the sensor 29 as described previously.

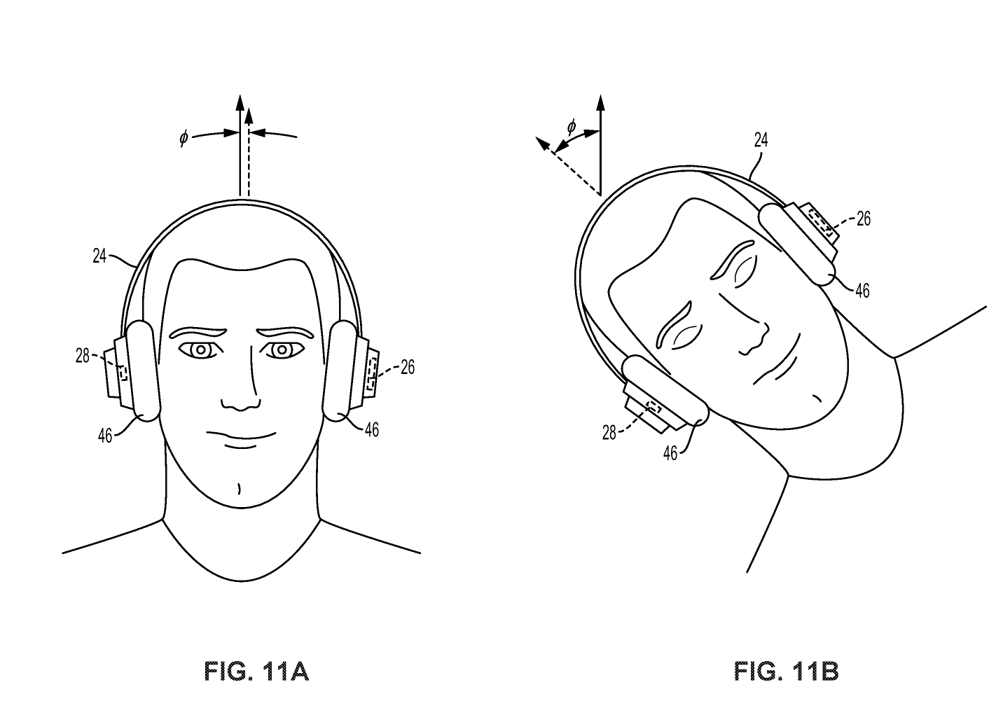

FIG. 11A is an illustration of the user 30 wearing a wireless headset 24 while viewing a media program. The wireless headset 24 receives the audio portion of the program as described previously. The audio portion of the program is provided to the user 30 via the headphones 46 of the television receiver 24. The wireless headset 24 includes a transceiver 26 by which the wireless headset 24 receives the audio portion of the media program. The wireless headset 24 further includes sensor 28 which detects the movements and orientation of the users head.

In one embodiment, the sensor 28 includes one or more accelerometers and/or gyroscopes that detect the orientation of the users head. In FIG. 11A the user's head is oriented at a small angle theta with respect to vertical. Sensor 28 monitors the angle the users head with respect to vertical. While the users head is upright and oriented at a small angle theta with respect to vertical, the sensor 28 detects that the user is awake.

In FIG. 11B, the user has fallen asleep while watching the media program. Wirelessly, the user's position has shifted such that the users head now makes a much larger angle theta with respect to vertical. In one embodiment, if the sensor 28 of the wireless headset 24 detects that the user's head is oriented with an angle theta that is larger than a threshold angle for a period of time exceeding a threshold time, the sensor 28 determines that the user has fallen asleep. In one example, the threshold angle is 30° with respect to vertical and the threshold time is five minutes. Other suitable values for the threshold angle and threshold time can be chosen as will be recognized by those of skill in the art in light of the present disclosure. In determining whether the user has fallen asleep, the sensor 28 can take into account whether the user's head is leaning back, to the side, etc.

In one embodiment, the sensor 28 monitors the movements of the users head. While a user is awake, the user's head will typically make small movements from time to time such as briefly looking away from the television 34, nodding, jostling due to laughter, etc. When the sensor 28 detects such characteristics head movements, the sensor 28 determines that the user is still awake. However, when the user has fallen asleep, the users head will typically not move at all for relatively long periods of time. If the sensor 28 determines that the users head has not move significantly for a duration of time greater than a threshold period of time, the sensor 28 determines that the user has fallen asleep. Sensor 28 causes the transceiver 26 to power down as described previously.

The sensor 28 can be utilized in many ways to determine if the user has fallen asleep. The sensor 28 can determine whether the user has fallen asleep based on a combination of head orientation and head movements or other factors as will be apparent to those of skill in the art in light of the present disclosure. All such ways of determining whether the user has fallen asleep fall within the scope of the present disclosure.

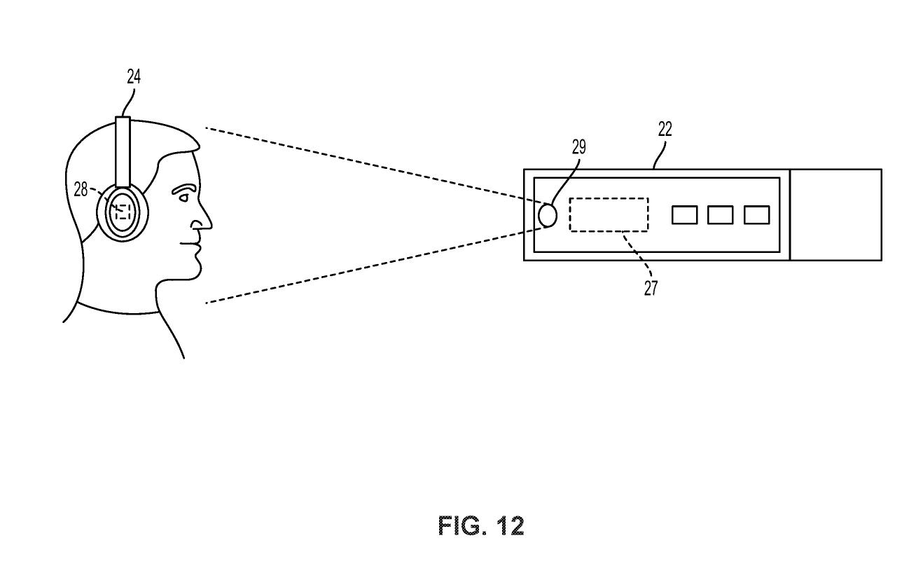

FIG. 12 is an illustration of a user 30 viewing a media program while wearing a wireless headset 24. The television receiver 22 is monitoring the user via a sensor 29 to detect if the user has fallen asleep. In the illustration of FIG. 12 the television receiver is shown as being directly in front of the user and at a level with the users head. In practice, the television receiver 22 may not be directly in front of the user but will be above, below, or to the side of a television 34 on which the user is viewing the media program.

In one embodiment the sensor 29 includes one or more cameras that monitor the user's eyes. The camera can monitor the user's eyes to determine if the user is awake or asleep. If the sensor 29 detects that the user's eyes are closed for a period of time longer than a threshold period of time, the sensor 29 determines that the user has fallen asleep and transmits the power down command to the wireless headset 24 as described previously.

Alternatively, the sensor 29 can monitor the orientation and/or movements of the users head. As described previously, the orientation and movements of the users head provide an indication of whether the user is awake or sleep. If the sensor 29 determines that the user has fallen asleep based on the movements and/or orientation of the users head, the television receiver 22 transmits the power down command to the wireless headset 24 as described previously.

In one embodiment, the sensor 29 is a video camera that detects when the user is wearing the wireless headset 24. If the video camera 29 indicates that the user is not wearing the wireless headset 24, then the television receiver 22 can transmit a command to power down the wireless headset 24. In a similar manner, if the video camera indicates that the user has put on the wireless headset 24, then the television receiver 22 can transmit a command to turn on the wireless headset 24. Alternatively, the sensor 29 can be a camera that periodically takes a picture. The television receiver 22 then analyzes the picture to determine whether or not the wireless headset is being worn by the user and powers down or powers on the wireless headset 24 accordingly.

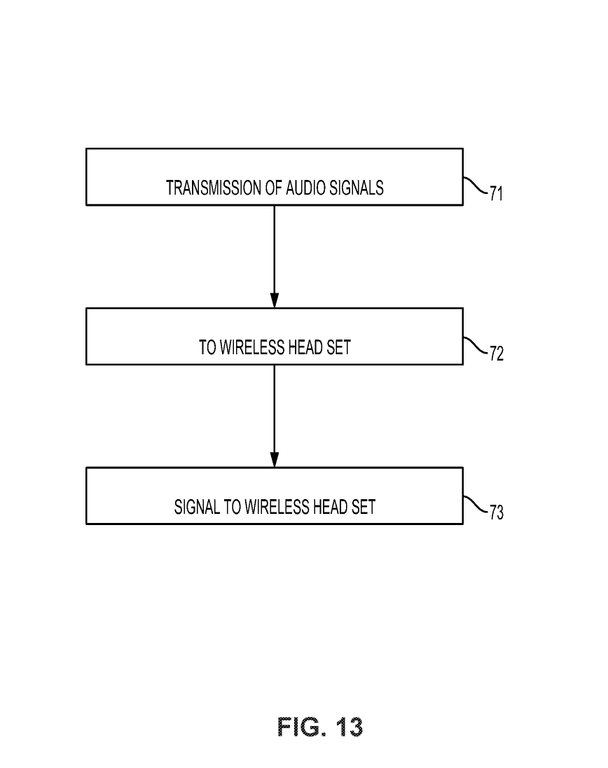

FIG. 13 is a flowchart of a process for preserving batteries in a wireless headset 24 worn by a user while viewing a media program as described previously. At 71 the user inputs via a remote control 32 commands to a television receiver 22 indicating that at the end of a particular program or at a particular time, the television receiver 22 should send a power down signal to the wireless headset 24 in order to preserve the battery life of the wireless headset 24 in case the user falls asleep while wearing the wireless headset 24 or forgets to turn off the wireless headset 24.

At 72, the television receiver 22 outputs to the wireless headset 24 the audio portion of a media program that the user is viewing on the display coupled to the television receiver 22. At 73, the selected program ends or the selected stop time arrives and the television receiver 22 transmits a power down signal to the wireless headset 24. When the wireless headset 24 receives the power down signal, the wireless headset 24 turns off wireless transceiver 26 or shuts down altogether.

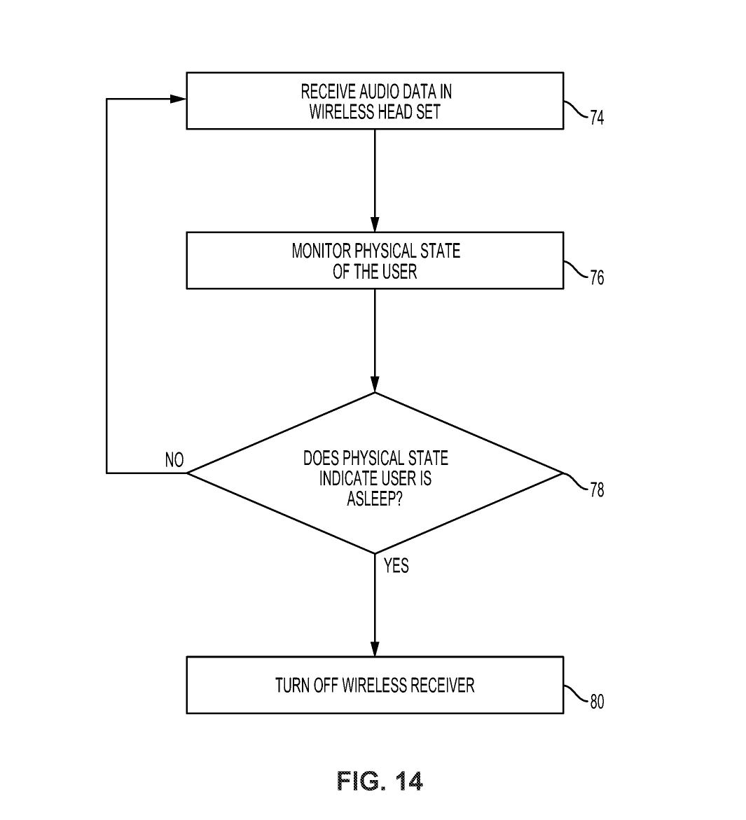

FIG. 14 is a flowchart of a process for preserving batteries in a wireless headset 24 according to an alternative embodiment. At 74, the wireless headset receives the audio portion of a media program from a television receiver 22. At 76, sensor 28 and/or 29 monitors a physical state of the user. The sensor 28 and/or 29 can be housed in the television receiver 22 or in the wireless headset 24 as described previously. At 78, if the sensor 28 and/or 29 detects that the user has not fallen asleep, the wireless headset 24 continues to receive the audio portion of the media program. If the sensor 28 and/or 29 detects that the user has fallen asleep then at 80 the transceiver 26 of the wireless headset 24 is powered down.

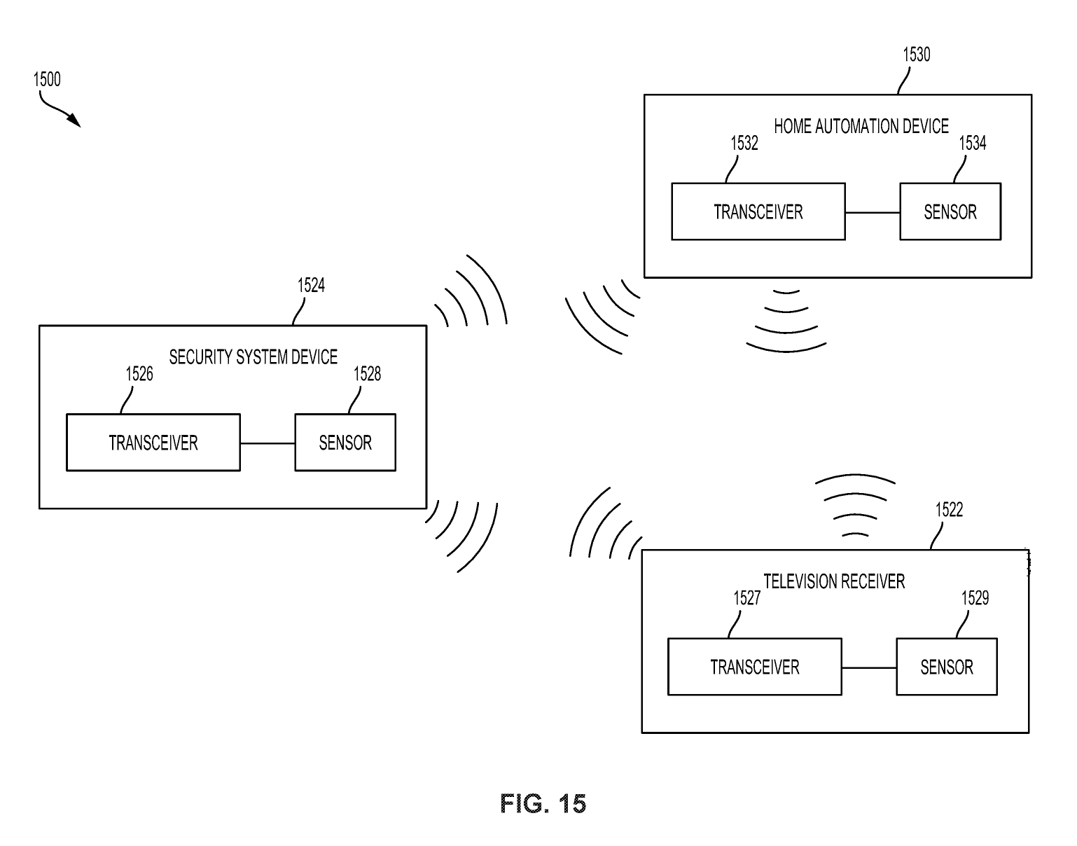

FIG. 15 is a block diagram of a system 1500 including a television receiver 1522, a security system device 1524, and a home automation device 1530. Each of the television receiver, security system device, and home automation device may include a transceiver and/or a sensor. For example, as shown in system 1500, television receiver 1522 may include a transceiver 1527 and a sensor 1529, security system device may include a transceiver 1526 and sensor 1528, and home automation device 1530 may include a transceiver 1532 and sensor 1534. However, system 1500 may include only one or two of the television receiver 1522, security system device 1524 and home automation device 1530. For example, system 1500 may include only home automation device 1530 and security system device 1524. Home automation device 1530 may be a part of a home automation system, which may include multiple home automation devices, as described herein with respect to FIGS. 3 and 4.

The home automation device 1530 and/or security system device 1524 may be powered by batteries. If the batteries become depleted, the home automation device 1530 and/or security system device 1524 may become inoperable until the batteries are replaced or recharged. The transceiver the devices may consume a relatively large amount of energy when it is receiving or transmitting information related to a media program or other information. The home automation device 1530 and/or security system device 1524 may also be powered by AC power, or another constant supply of power, from a power company, which may cost money per amount of power used. To avoid the inconvenience of having to frequently replace rechargeable batteries or to use unnecessary power, the system 1500 may include functionality designed to reduce the amount of power consumed by the wireless headset, particularly when the user is no longer using the wireless headset or has fallen asleep.

The home automation device 1530 and/or security system device 1524 may also be changed periodically throughout the day to adjust for the current environment of the user(s) and the home that they are located in. For example, the user may not want the security system to be armed during certain parts of the day while people are entering and leaving the home on a regular basis, but the user may want the security system to be armed at night when the user is home and sleeping to protect the user from intruders or other possible threats. In another example, the user may want the security system to be fully armed with motion detectors during the day when the user is at work, but may want only certain aspects of the security system to be armed at night when the user is home and sleeping.

In one embodiment, the television receiver 1522 includes an electronic programming guide which can be accessed by the user to view which media programs are available on particular channels at particular times. By operating a remote control, or by utilizing inputs coupled directly to the television receiver 1522, the user can access the electronic programming guide and can select a media program to view or change other settings or controls related to the television distribution system, including for example television receiver 1522. When the user selects, for example, a media program to view, the user can also enter input directing the television receiver to send a command to the home automation device 1530 and/or security system device 1524. For example, the command signal may indicate that the home automation device 1530 or security system device 1524 should make a change to the home automation system or security system, respectively, based on an event that occurred, such as a media program completing. In a more specific example, at the end of the media program, the television receiver 1522 may transmit a wireless command signal to the home automation device 1530 and/or security system device 1524 to turn a setting on, change a setting, enter a reduced power state, or turn off entirely, among others. In another example, if the user falls asleep, the user may forget to turn on the home security system.

This feature can be of particular use when the user anticipates that the user may fall asleep during the media program. In many cases a user plans to make a change to the home automation device 1530 and/or security system device 1524 at the end of the selected media program, but either forgets to make the change or falls asleep during the program such that the user is unable to make the change. When the user returns at a future time to make another change to the home automation device 1530 and/or security system device 1524, he may find that the initial change was never made. It may be both inconvenient and expensive to repeatedly leave certain home automation and security system devices in certain states that are not appropriate for the conditions of the home.

However, the functionality of the system 1500 allows the user to avoid this situation by enabling the user to choose to make a change to the home automation device 1530 and/or security system device 1524 at the end of a selected media program, or after a determination is made that the user has fallen asleep. If the user then forgets to make the change, the home automation device 1530 and/or security system device 1524 will nevertheless automatically make the change.

In one embodiment, the sensor 1534 of the home automation device 1530 detects when a user has fallen asleep. The sensor 1534 may determine that a user has fallen asleep in a variety of ways. For example, sensor 1534 may monitor a physical state of the user. When the sensor 1534 detects that the user has fallen asleep based on the physical state, the sensor 1534 outputs a signal to control circuitry of the home automation device 1530 causing the home automation device 1530 to make a change in the home automation device 1530 or in another aspect of the home automation system in which the home automation device 1530 is a part of. In another example, the home automation device 1530 may output a signal to control circuitry of the security system device 1524 (the signal received, for example, by transceiver 1526 of security system device 1524) instructing the security system device 1524 to make a change in the security system device 1524 or in the security system that the security system device 1524 is a part of. In a more specific example, the signal may include a command to turn the security system into an “on” state from an “off” state.

Although herein sensor 1534 may be referred to as detecting that a user has fallen asleep, sensor 1534 may not make the determination itself. For example, sensor 1534 may collect data related to such a determination, and may either make a determination of the user's state by itself, or may send the data to a different device for that different device to make that determination. Such a different device may be television receiver 1522, for example.

Furthermore, although herein sensor 1534 may be referred to as detecting that a user has fallen asleep or collecting data related to such a determination, similar determinations or collections of data may be performed by different sensors, such as sensor 1528 in security system device 1524 or sensor 1529 in television receiver 1522.

In one example, the sensor may be an inertial sensor that detects the motion of the user's head. Commonly, when a user is awake, the user's head will make particular shifting movements such as nodding, quickly moving to look another direction then moving back, and many other kinds of movements. In contrast, when the user is asleep, the head moves very little or only makes certain kinds of movements particular to a state of sleep. Based on these movements, the sensor may be able to detect whether the user is awake or asleep. If the motion of the user's head, as detected by the sensor, indicates that the user is asleep, the sensor can output a signal causing a change in setting or performance of home automation device 1530, security system device 1524, television receiver 1522, or other aspects of the respective systems that those devices are a part of.

Other types of sensors may also be used, as described further with respect to FIG. 7. For example, the sensor may include a microphone or other type of sensor that senses the breathing (individual breaths, breath patterns, etc.) of the user. A user's breathing pattern can indicate whether a user is sleeping due to different breathing patterns when a user is sleeping than when a user is awake, such as the frequency of the breathing. In another example, a sensor can include a pulse rate monitor configured to measure the heart rate of the user. The heart rate of the user can indicate whether the user has fallen asleep due to a change in heart rate because the heart rate of a user typically decreases to a level that is significantly lower than the heart rate of the user when the user is awake. After it has been determined that the user has fallen asleep, the home automation device (or another device in the home automation system) may transmit a signal to the security system device 1524 to make a desired change in the security system, such as, for example, turning the security system “on”. In addition or instead, the home automation device 1530 may transmit a signal to television receiver 1522 indicating that the user is asleep. Once the television receiver 1522 has received a signal indicating that the user is asleep, the television receiver 1522 may transmit a signal to the security system device 1524 to make the desired change in the security system. The television receiver 1522 can also transfer command signal to the display or to other media devices coupled to the television receiver 1522.

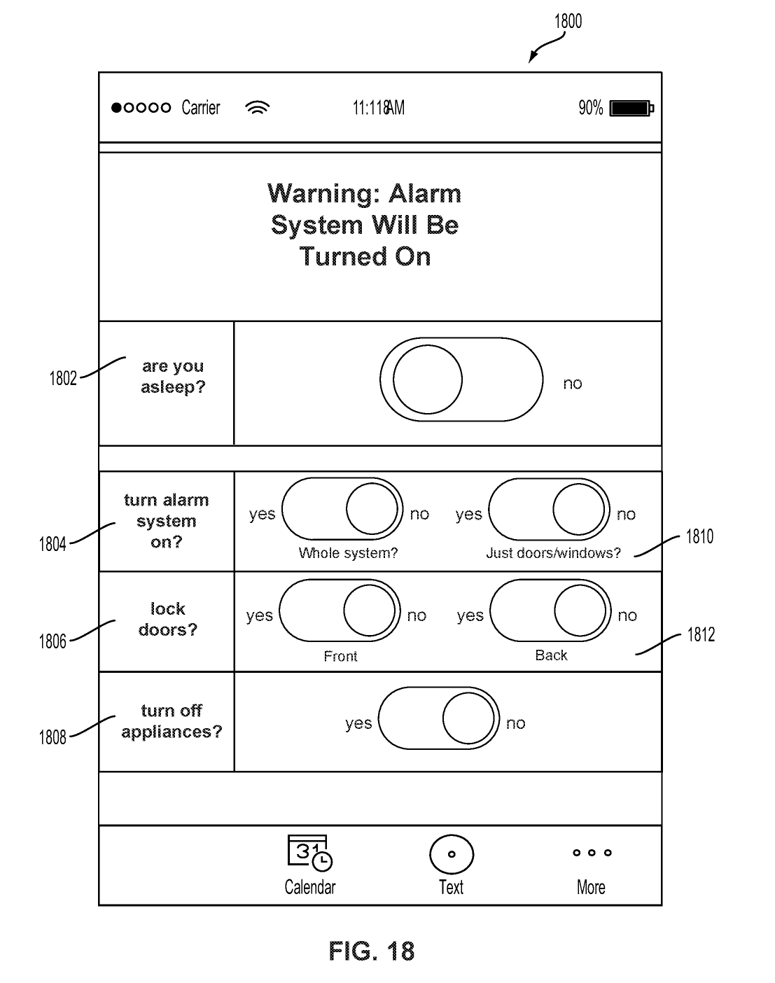

The sensor 1534 or sensor 1528 can also cause the security system to again change a setting, such as reverting back to its original settings from before the user fell asleep, when the user wakes up. For example, sensors 1534 and/or 1528 can still be in a functioning state and continue to monitor the physical state of the user. If the physical state of the user indicates that the user has woken up, a sensor can transmit another signal to the security system device 1524 indicating that another change should take place in the security system device. The home automation device 1530 can also transmit signals to the television receiver 1522 or other media devices indicating that the user has woken up. If the television receiver 1522 or other media devices entered a low power or off mode and/or paused or recorded a media program due to the user falling asleep, television receiver 1522 can immediately resume playing the media program upon notification that the user has woken up. Alternatively, the television receiver 1522 or other media device, home automation device 1530 and/or security system device 1524 can notify the user that the media program was paused or recorded upon detecting that the user fell asleep. The television receiver 1522 or other media device, home automation device 1530 and/or security system device 1524 can prompt the user for input regarding whether the user would like to immediately begin playing the paused or recorded program, or take other action regarding the television receiver 1522 or other media device, home automation device 1530 and/or security system device 1524. Further interaction between a user and such a display (e.g. on a mobile device) is described further with respect to FIG. 18.

In one embodiment, if sensor 1529 of the television receiver 1522 monitors a physical state of the user and detects that the user has fallen asleep, the television receiver 1522 can transmit a signal via transceiver 1527 to the home automation device 1530 and/or security system device 1524 indicating that the user has fallen asleep. In response to receiving the signal from the television receiver 1522, the devices in system 1500 may take similar actions to those described herein.

In one embodiment, the sensor 1529 of the television receiver 1522, sensor 1534 of home automation device 1530, and/or sensor 1528 of security system device 1524 may include a camera that can monitor the eyes of the user. The sensor can detect if the user's eyes are open or closed. If the sensor detects that the user's eyes are closed for an extended period of time, then the system 1500 may determine that the user is asleep. For example, a device in the system may determine that the user is sleeping because the user's eyes have been closed for greater than a predetermined amount of time. The amount of time used as the predetermined time threshold may change over time, and may change based on the user being monitored, using data about the user collected over time. In other words, the sensors in devices within system 1500 may monitor and dynamically learn the user's habits/routines and use that information to determine what data (e.g. average data) should be used to determine when a specific user has fallen asleep, and therefore when certain desired changes should be made within the system. For example, the television receiver 1522 may detect that the user commonly watches the evening news, turns off the television receiver 1522 after the news has ended, and turns the security system “on” after that. On a particular day, the television receiver 1522 may detect that the user has not powered down the television receiver 1522 and turned the security system “on” after the conclusion of the evening news. The television receiver can assume, after a certain dynamic predetermined amount of time, that the user might have fallen asleep and that this is the reason for the break from the user's normal routine. In such a situation, the television receiver 1522 may transmit a prompt on a display indicating that one or more devices will be powered down unless the user provides feedback (e.g. an input into the display, an audible statement command detected by the display or television receiver 1522, a button press on a device or remote control, etc). If the user does not respond then a desired action may be taken.

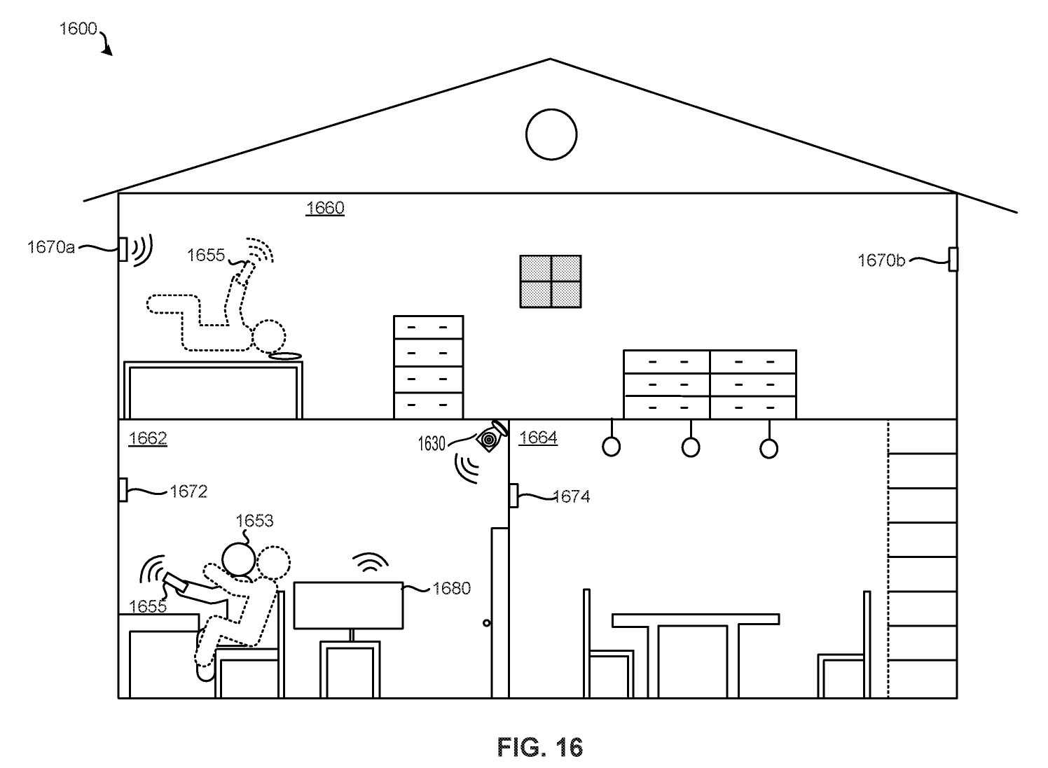

FIG. 16 illustrates a structure 1600 that includes a dwelling with a home automation system and a home security system connected to the dwelling, according to embodiments of the present technology. The structure 1600 includes three different rooms 1660, 1662 and 1664. As shown in FIG. 16, room 1660 is a bedroom, room 1662 is a living room, and room 1664 is a dining room. Included in the structure 1600 is a home automation system. The home automation system may include home automation devices. The home automation system may include various sensors that may be distributed around the structure, such as sensors 1670a, 1670b, 1672, and 1674. Sensors 1670a, 1670b, 1672, and 1674 may be, for example, motion detectors, video cameras, temperature sensors that record temperature readings of the current temperature of the room that the sensor is located in, among others. Sensors 1670a, 1670b, 1672, and 1674 may compile recordings of data over a period of time. The recordings may be stored locally at each sensor, or may be transmitted from the different sensors to a central location, such as to a television receiver (e.g. a television receiver that is a part of television 1680) or other home automation processing unit for storage.

Also included within structure 1600 may be a home security system. Home security system may also include one or more sensors that observe and monitor the different rooms in the structure for the purpose of indicating when an unwanted person is present in the structure, or other information. For example, the home security system may include a video camera 1630 as shown in FIG. 16. Security system video camera 1630 may view portions of room 1662 and collect data regarding the environment in room 1662. Video camera 1630, or a device connected to video camera 1630, may include certain hardware or software that allows the home security system to determine what types of objects, or people, that the video camera sees. For example, the security system may include facial recognition software, or other recognition software, to determine when a certain user (or unwanted non-user), such as user 1653, is present in the room. In another example, video camera 1630 may be configured to detect certain characteristics about user 1653, including physical characteristics regarding the user's position, actions, non-action, among other characteristics. Using the home automation system and television receiver, a user may be able to control, based on user initiated settings, how the security system devices and home automation devices function and how they can be tailored to the user. For example, user 1653 may use mobile device 1655 (e.g. mobile phone, remote control, etc.).

Although the home automation system and security system may be described using various different features or types of sensors, such sensors may overlap both systems, may be present in either system, or may be a part of both systems. Furthermore, the home automation system and home security system may share data collected for use by the other corresponding system to make determinations for its own purposes.

As noted, a home automation device, security system device, and/or television receiver may include sensors that can detect when a user has fallen asleep. For example, as shown in FIG. 16, user 1653 may lean back in the user's chair. Sensor 1630 may detect that user 1653 has fallen asleep by detecting certain physical characteristics that indicate a user's state of sleeping, such as that the user has leaned back in the user's chair and/or hasn't moved for a certain period of time. In other examples, sensor 1630 may detect when a user's eyes have closed, when a user is lying down on a couch, or when a user has not moved more than a certain amount for a certain amount of time, among other examples. A sensor within television 1680 (e.g. within a television receiver within television 1680) may also detect certain actions or inactions taken by the user. In certain examples, this sensor may detect that a user hasn't changed the channel on the television for an extended period of time. This period of time may be beyond a certain predetermined threshold. The threshold may be dynamically determined based on the user's actions. For example, if a certain user does not generally go more than 15 minutes without changing the channel, then the threshold may be less than for a user that generally watches at least 1 hour of television on the same channel without changing the channel. The sensor may also detect that a user has fallen asleep because the user is “watching” a channel (i.e. the television receiver is set to a certain channel) that the user has historically never watched, or a channel from which the user has always changed channels within a certain short predetermined amount of time.

The home automation system and/or security system may also determine that a user has moved into a portion of the structure 1600 in which the user usually sleeps. For example, the home automation system may detect that a user has moved from room 1662, a living room, to room 1660, the user's bedroom. The home automation system may also determine that the user is in a position in which the user usually sleeps, such as lying down as shown in FIG. 16. This location may be determined in a variety of ways, including a global positioning system (GPS) within a mobile device, video or motion sensors, communication with mobile device 1655, among other techniques.

As noted herein, there are a variety of other ways for a home automation, security, or television system to determine when a user has fallen asleep. An indication that a user has fallen asleep may be used to take action within one or more of the systems based on a user's predetermined preferences or dynamic learned preferences over time, such as adjustments to security system devices.

As noted, mobile device 1655 being held by user 1653 may be a remote control for television 1680, where the remote control may allow the user 1653 to make changes on television 1680, via a television receiver connected to television 1680 or otherwise. By using the remote control, the user 1653 can access menu screens of the television receiver. In the menu screens, the user can select a particular media program after which the television receiver should transmit a command to home automation or security system devices. For example, the user may wish to watch a television show at 11:00 PM. Prior to or during viewing of the television show, the user can access the programming guide and can select the television show as a final media program to be viewed that night. In this way the user can tell the television receiver to transmit the signal to, for example, a security system device to turn on the security system device (or the security system as a whole) at the conclusion of the program. In an alternative embodiment, the user can select, from the menu screens of the television receiver, a particular time at which to transmit the signal to the security system based on the user's preferences.

In one example, the user can sit down to the various television programs on the television 1680. If user expects to be done watching television by 1:00 AM (e.g. the user expects either to have fallen asleep while watching television or to have gone to bed by 1 AM), the user may access the menu screens of the television receiver and designate 1:00 AM as a time after which the security system should be turned on. Therefore, at 1:00 AM the television receiver transmits a signal to the security system device (either via the home automation system or directly to the security system) causing a change in the security system device.

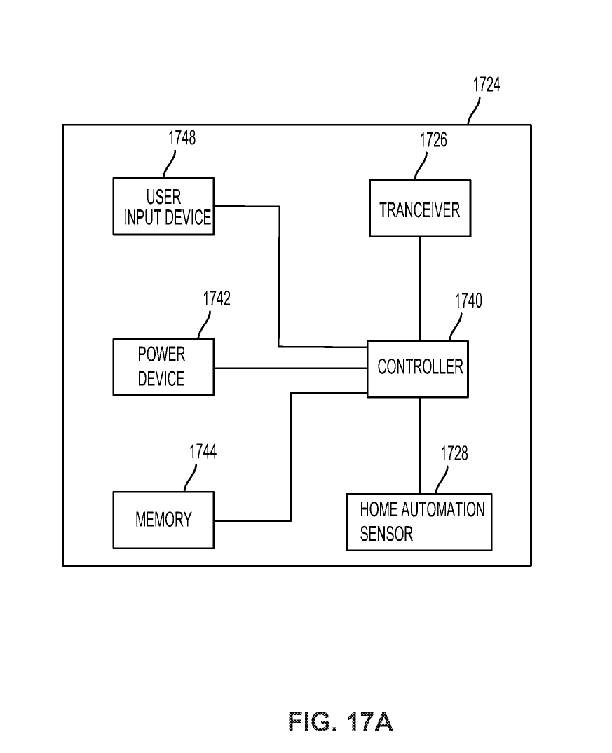

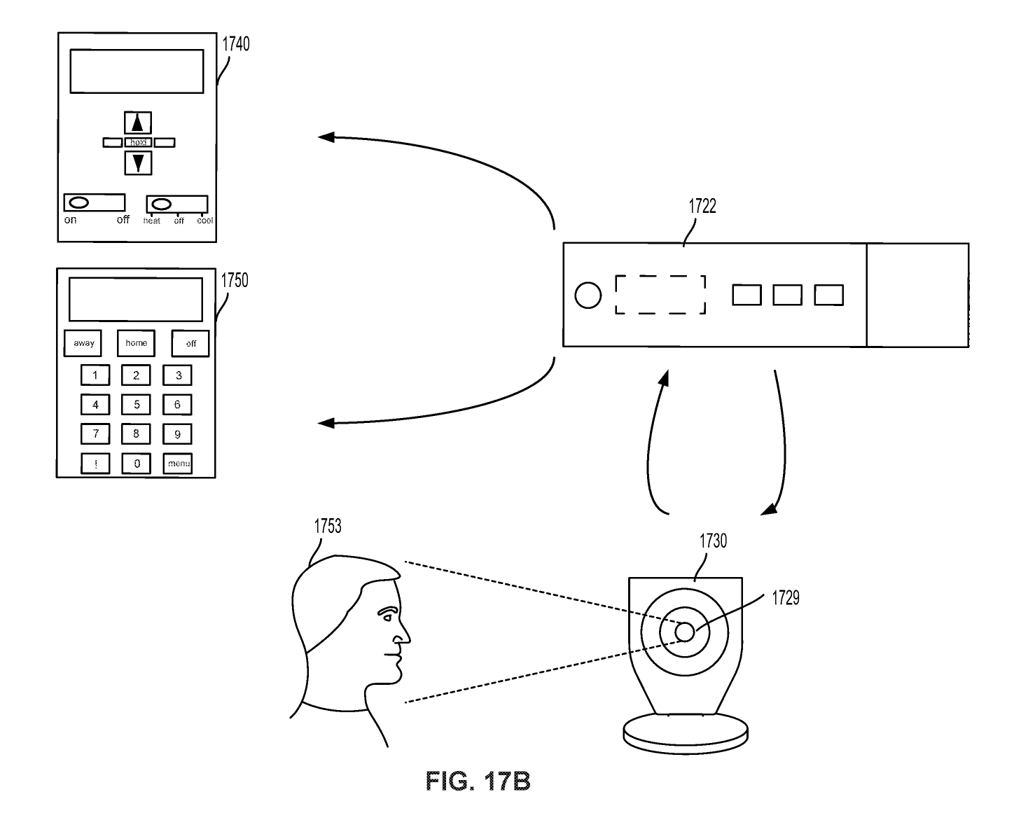

FIG. 17A is a block diagram of a home automation device, according to embodiments of the present technology. The home automation device 1724 could also be a security system device, such as security system device 1524 from FIG. 15. The home automation device 1724 includes a controller 1740. The controller 1740 is coupled to a power device 1742. The controller 1740 is further coupled to a memory 1744, user input device 1748, transceiver 1726 (e.g. a wireless transceiver), and home automation sensor 1728. The controller 1740 is configured to execute instructions stored in the memory 1744 to perform the functions of the home automation device 1724.

The transceiver 1726 includes one or more wireless transmitters and receivers by which the home automation device 1724 communicates with other devices. The controller 1740 controls the transceiver 1726. The transceiver 1726 may receive data from other home automation devices, from a connected television system, or other devices connected to the home automation device 1724. The collected data may be directed to, for example, a user and whether the user is asleep or not. In one embodiment, the transceiver 1726 includes IR and RF transmitters and receivers including a Bluetooth transceiver. The transceiver 1726 can also transmit signals to a television receiver and other electronic media devices, for example indicating that a user has fallen asleep. For example, the transceiver 1726 may also transmit data collected at, for example, home automation sensor 1728. In this way the transceiver 1726 can cause the home security system to make setting changes, such as turn on or off, based on the data collected at sensor 1728.

A user can control the home automation device 1724 at the user input device 1748. User input device 1748 can include on, off, and standby keys, volume control keys, transceiver control keys or any other keys suitable for allowing the user to interact with and control the home automation device 1724. The user input device 1748 can also be on the remote control for the television receiver connected (e.g. wirelessly) to the home automation device. The remote control can send signals to the television receiver which will store the program for the home automation device 1724 and then output signals to control it.

The sensor 1728 may monitor one or more physical states or characteristics of the user. The sensor 1728 can detect whether the user has fallen asleep based on the physical states or characteristics monitored by the sensor 1728. The sensor 1728 can include one or more accelerometers, gyroscopes, microphones, pulse rate monitors, breathing monitors, cameras, or any other suitable device for detecting whether the user has fallen asleep. The controller 1740 may control the sensor 1728 and receives signals from the sensor 1728 indicating the physical state of the user. In one embodiment, the controller 1740 detects whether or not the user has fallen asleep based on comparing the signals received from the sensor 1728 to data stored in the memory 1744. For example, such stored data may include data collected at a previous (historical) day and/or time. This historical data may have been data used to determine that the user was awake so that, when compared to the current collected data, a certain difference may indicate that the user is in a different state (e.g. asleep). If the controller 1740 determines that the user has fallen asleep, the controller 1740 can cause the transceiver 1726 to output a signal to a television receiver, a television, or any other electronic media device associated with the home automation or security system. The controller 1740 can shut down the transceiver 1726 or a portion of the transceiver 1726 based on instructions stored in the memory 1744. This shut down may take place to save battery or other power at the device(s) that receive data transmissions from the home automation device 1724. The controller 1740 can also cause changes in other devices, such as security system devices. For example, controller 1740 may transmit a signal to the home security system to turn the system on, or change certain settings/features in the system. The controller 1740 can also cause the transceiver 1726 or other components of the home automation device 1724 to wake up and resume full functionality when the sensor 1728 indicates that the user has woken up, or transmit signals that makes additional changes to the home security system now that the user is awake.

Those of skill in the art will understand that the home automation device 1724 can include many more or fewer components than those disclosed in the block diagram of FIG. 17A depending on the particular specification and design of the home automation device 1724 in accordance with principles of the present disclosure, and such configurations may fall within the scope of the present disclosure.

FIG. 17B illustrates a flow diagram showing communications between devices within a home automation and/or security system, according to embodiments of the present technology. FIG. 17 shows a user 1753 and a sensor 1730, which may be, for example, a video camera with a lens 1729. The sensor 1730, using lens 1729, may view its environment, which may include user 1753. Sensor 1730 may collect data associated with user 1753, such as characteristics about the user that may help sensor 1730, or another device that may receive the data from sensor 1730, determine a state of the user. For example, a determined state of the user may be if the user is sleeping, if the user is unconscious, if the user has passed out, among others. However, the state may be related to the user being immobile such that the user may want the user's security system to be turned on, or another change in a home automation or security system device. Various ways to determine that the user is sleeping is described further herein.

Sensor 1730 may communicate with other devices in a home automation system, home security system, and/or television distribution system. For example, sensor 1730 may communicate with television receiver 1722. Sensor 1730 may receive data from television receiver 1722 regarding user 1753, among other data. The received data may include information about preferences of user 1753, characteristics or other data observed by television receiver 1722 using a sensor within television receiver 1722 or using interactions with the user via a remote control or other mobile device, or characteristics unrelated to user 1753. Furthermore, sensor 1730 may transmit data to television receiver 1722, including data collected by observing user 1753. The user data may be related to one or more states or characteristics of the user, which may be used to determine if the user is sleeping. Sensor 1730 may also communicate directly with devices within a home automation system, such as temperature sensor (e.g. thermostat) 1740, or devices within a security system, such as security keypad 1750. Collected data may be collected over time to represent a historical perspective on user 1753 and what actions the user 1753 takes over the course of an hour, a day, a week, a month, a year, etc.

Television receiver 1722 may use the data collected at sensor 1730 to make determinations about the user. For example, the television receiver 1722 may make determinations about the state or characteristics of the user. The television receiver 1722 may use the data collected by sensor 1730, along with other data collected from other sensors, or data collected by the television receiver 1722 itself, to educate itself on the user and the user's preferences, patterns, etc.

After sensor 1730 or the television receiver 1722 has made a determination about the user, such as that the user has fallen asleep, the television receiver 1722 may make a change within the television distribution system based on the user's preferences or selections or based on a user profile generated by the television receiver 1722 over time. For example, television receiver 1722 may transmit a command to security system device 1750 to tell the device to take an action within itself or within the entire security system. For example, the television receiver 1722 may transmit a command to device 1750 to turn the security system “on”, such as to turn on the motion sensors and/or door/window sensors within the security system. The television receiver 1722 may send such a command for the security system to turn “on” specific sensors based on the user's preferences saved in memory, or based on real time inputs received from the user (e.g. if the user is not yet asleep, or right before the user falls asleep). For example, if the user knows that the user is tired and may fall asleep shortly, the user may input a command into the television receiver 1722 to turn on certain security system sensors if the user falls asleep. Such inputs are discussed further with respect to FIG. 18. In another embodiment, the television receiver 1722 may send a command to turn on certain security system sensors that the television receiver 1722 knows the user usually turns on at that time of the day.

After such a command is received by the security system device 1750 (or by HVAC sensor 1740), the device may take an action internally to make a change to the device itself, another device, or the system as a whole, or may transmit another command to another device within the home security or home automation systems to make a change in another device or for another device to take a certain action.

Other types of sensors other than a video camera, as shown in FIG. 17B, may be used to collect data about user 1753. For example, sensor 1730 may be a mobile phone, smart glasses, smart watch, motion detector, a microphone, a television, remote control, headset, or other devices.

Other types of devices may receive commands to make a change within the device once the home automation system or television system determines that the user has fallen asleep. For example, such devices may include kitchen appliances (e.g. stove, oven, toaster oven, refrigerator), other home appliances (e.g. garage door opener, hair straightener, crock pot, soda maker), home electronics (e.g. television, tablet computer, personal computer, lights, water faucet), among others. Various actions can be taken by these devices, or by control devices that make changes to those devices. Such actions could include turning the device on/off, changing a setting in the device (e.g. dimming a light, lowering volume of a television or radio, lowering temperature in refrigerator, lowering temperature in HVAC system or kitchen appliance), or setting the device to take an action at a later time, among others.

Various types of data may be collected at a sensor, depending on the type of sensor. For example, for a temperature sensor, data may be collected regarding temperature in the room over a period of time, when the air conditioning and/or heat went on or off, the rate at which temperature dropped or rose, among other types of data. In another example, for a video camera, data may be collected regarding when motion was detected, for how long the motion persisted, who or what caused the motion (e.g. using facial recognition), when the video camera was turned on or off, among others.

One control device within the home automation or security system may ultimately compile and analyze the data collected by sensor 1730 and other sensors in the systems. This control or central device may generate a profile based on the data it receives from the devices. For example, the user profile may be the result of analysis done on the data regarding characteristics of one or more devices and/or on the user. For example, if a home automation device detects data in a certain pattern, or detects data that is representative of a certain characteristic associated with the device, the profile may reflect such a pattern or characteristic. For example, if sensor 1730 is a motion detector in a basement of a home detects motion in the basement every day between 8:10 AM and 8:20 AM, then the home automation profile may include such a pattern. These patterns and/or characteristics may allow the home automation system to give advance warning of an upcoming action to a user, or may allow the home automation system to take an action automatically based on the event that it assumes will take place at a given time. For example, such an action may be taken if the system determines that the user has fallen asleep.

In addition to data automatically detected and collected by the home automation sensors, a user profile may also include information inputted by the user. For example, a user may input preferences into a user interface directed to preferences about how the user would like the home automation system, security system, or specific devices to function. In one example, a user may enter an input into a television receiver via a remote control device regarding the temperature that the user would like in a certain room in the user's home. In another example, a user may input information related to home automation devices into a remote control associated with the television receiver, into a mobile device, or other user interface such that the information inputted by the user is received by control processor within a device of the home automation system for processing. Also as noted, the home automation system may include sensors in multiple rooms or areas within a structure that are configured to record data corresponding to the environment in which the sensors are in.

FIG. 18 shows a graphical user interface (GUI) on a display 1800 connected to a home automation and security system, according to embodiments of the present technology. The GUI may be located on a mobile device, television, or other device connected to a home automation system for a user to receive queries and/or input responses to the queries or other preferences.

Display 1800 may include one or more queries presented to a user of the mobile device. The queries may be related to a determination that the home automation system has made, and/or an action that the home automation system has directed a home security system, or another system or device, to take based on that determination. For example, if a home automation device has determined that the user has fallen asleep, and it believes that the home security system should be turned on, then the home automation system may transmit a communication to a mobile device that includes the display for the mobile device to display the query to the user.

In FIG. 18, display 1800 includes 4 different queries 1802-1808, and additional sub-queries 1810 and 1812. The first query, query 1802, asks the user whether the user is asleep or not. If the user is asleep, the user may slide the button to “no”. If the user slides the button to “no”, then the rest of the queries may become moot and disappear from display 1800. However, if the user does not move the button to the “no” position, then the mobile device may be able to assume that the user is asleep. Any response, or a communication indicating a lack of response, may be transmitted from the mobile device to the home automation system or security system to indicate whether the user is awake or not. This information may supplement (e.g. confirm, deny, etc.) the determination that the home automation system had already made based on the devices' observations from within the home automation system.

Additional data regarding the mobile device may be used to determine the accuracy of a non-response from the user. For example, the mobile device and/or home automation system may be the global positioning system (GPS) within the mobile device to determine if the mobile device is with or near the user. Other techniques may also be used to determine this accuracy or lack thereof. For example, home automation sensors within the home automation system, such as sensor 1730 in FIG. 17, may be able to observe the environment of the user and determine whether the user is near the mobile device. For example, if one sensor determines that the user is in one room, and another sensor determines that the mobile device is in a different room, the home automation system may determine that a non-response from the user at the mobile device is not indicative of an accurate state of the user.

Other queries, such as queries 1804-1808 may be used to both determine whether the user is sleeping (e.g. due to response vs. non-response) and what the user's preferences are with respect to home automation and security system devices. For example, query 1804 may be presented to the user (e.g. as requested or commanded by the home automation system or home security system) to determine if the user wants to turn on the alarm system, query 1806 to determine if the user wants to lock the doors, and query 1808 to determine if the user wants to turn off home appliances (e.g. kitchen appliances that could cause danger to the user or the user's home). Furthermore, subquery 1810 may be presented to determine whether the user wants to turn on the whole alarm system or only certain portions of the alarm system, and subquery 1812 may be presented to the user to determine if the user wants to lock the front door or back door or both. Any response, or a communication indicating a lack of response, may be transmitted from the mobile device to the home automation system or security system to indicate whether the user is awake or not. This information may supplement (e.g. confirm, deny, etc.) the determination that the home automation system had already made based on the devices' observations from within the home automation system.

In an example, if a user indicates via the GUI that the user wants to turn on the alarm system, for example by sliding one of the two buttons associated with that query to a “yes” position, then the mobile device may transmit this information to the home automation system and/or security system and the appropriate system may take action based on those inputs by the user, or may instruct the appropriate device to do so. The system may also override any determination it previously made about what action to take based on home automation sensors' observations of the user, since the user entered an active input and concrete answer to the system's queries.

The user may provide useful information to the display without receiving a query from the mobile device shown on the display. For example, the user may provide settings or conditions that are representative of the user's preferences or patterns without the home automation system having to determine such preferences and/or patterns on its own. Display 1800 may also be used for the user to periodically make inputs to tell the GUI, and therefore the home automation and/or security systems, what its preferences are. For example, a user may indicate in a list of settings that the user wants the security system to be turned on at 11:00 PM each night whether if the security system has not already been turned on manually as of that time. In another example, a user may indicate that the user wants the security system to be turned on if the user has been watching the same station for longer than 1 hour (e.g. if the user knows that the user tends to not watch more than 1 hour of television on the same channel in any given night). This indication may serve as a constructive determination that the user will either be asleep or that the user has forgotten to turn on the security system before going to bed if the condition has been met.

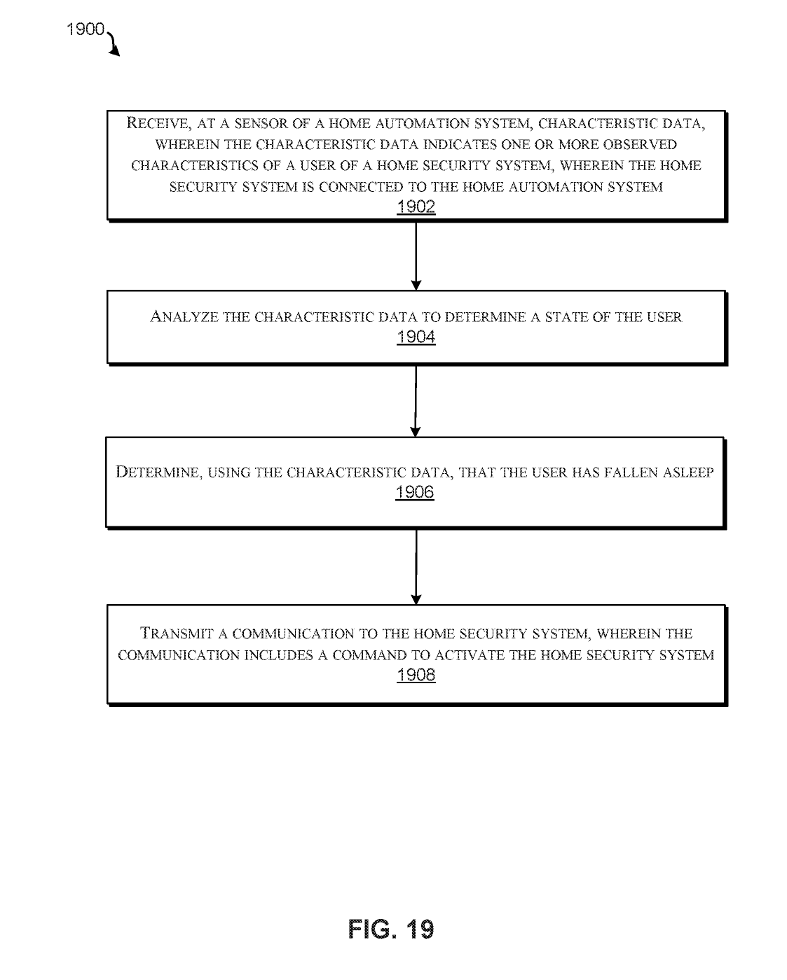

FIG. 19 is a flow chart of another example process used to adjust a security system based on a user falling asleep, according to embodiments of the present technology. Step 1902 includes receiving, at a sensor of a home automation system, characteristic data, wherein the characteristic data indicates one or more observed characteristics of a user of a home security system, wherein the home security system is connected to the home automation system. Step 1904 includes analyzing the characteristic data to determine a state of the user. The state of the user may be a physical state, mental state, or other type of state. Step 1906 includes determining, using the characteristic data, that the user has fallen asleep. The process may also include determining that the user is in a different state. Step 1908 includes transmitting a communication to the home security system, wherein the communication includes a command to activate the home security system.

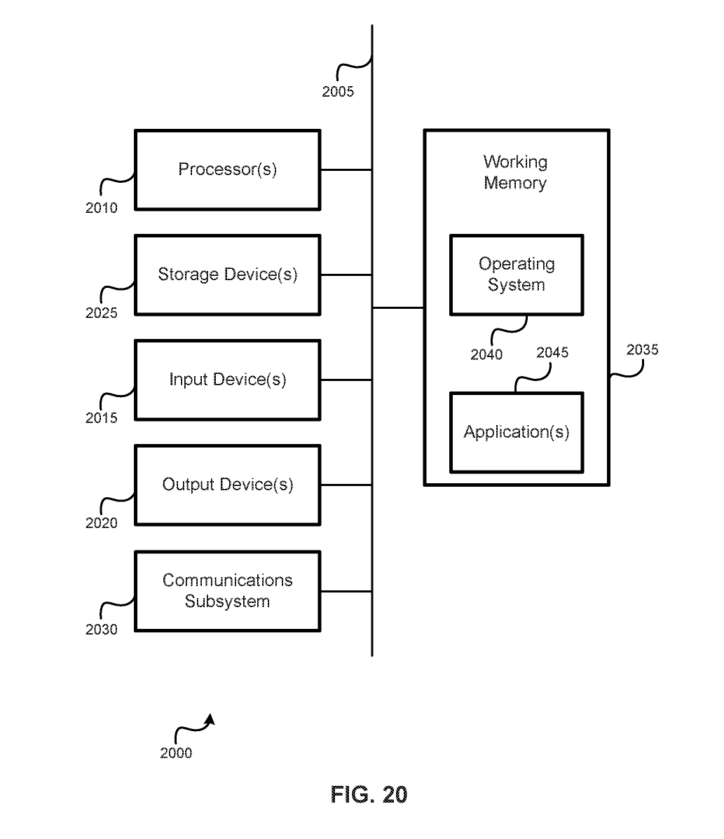

FIG. 20 illustrates an embodiment of a computer system 2000. A computer system 2000 as illustrated in FIG. 20 may be incorporated into devices such as an STB, a first electronic device, DVR, television, media system, personal computer, and the like. Moreover, some or all of the components of the computer system 2000 may also be incorporated into a portable electronic device, mobile phone, or other device as described herein. FIG. 20 provides a schematic illustration of one embodiment of a computer system 2000 that can perform some or all of the steps of the methods provided by various embodiments. It should be noted that FIG. 20 is meant only to provide a generalized illustration of various components, any or all of which may be utilized as appropriate. FIG. 20, therefore, broadly illustrates how individual system elements may be implemented in a relatively separated or relatively more integrated manner.

The computer system 2000 is shown comprising hardware elements that can be electrically coupled via a bus 2005, or may otherwise be in communication, as appropriate. The hardware elements may include one or more processors 2010, including without limitation one or more general-purpose processors and/or one or more special-purpose processors such as digital signal processing chips, graphics acceleration processors, and/or the like; one or more input devices 2015, which can include without limitation a mouse, a keyboard, a camera, and/or the like; and one or more output devices 2020, which can include without limitation a display device, a printer, and/or the like.

The computer system 2000 may further include and/or be in communication with one or more non-transitory storage devices 2025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 2000 might also include a communications subsystem 2030, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 2030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 2030. In other embodiments, a portable electronic device, e.g. the first electronic device, may be incorporated into the computer system 2000, e.g., an electronic device or STB, as an input device 2015. In many embodiments, the computer system 2000 will further comprise a working memory 2035, which can include a RAM or ROM device, as described above.

The computer system 2000 also can include software elements, shown as being currently located within the working memory 2035, including an operating system 2040, device drivers, executable libraries, and/or other code, such as one or more application programs 2045, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code might be stored on a non-transitory computer-readable storage medium, such as the storage device(s) 2025 described above. In some cases, the storage medium might be incorporated within a computer system, such as computer system 2000. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 2000 and/or might take the form of source and/or installable code, which, upon compilation and/or installation on the computer system 2000 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 2000 to perform methods in accordance with various embodiments of the technology. According to a set of embodiments, some or all of the procedures of such methods are performed by the computer system 2000 in response to processor 2010 executing one or more sequences of one or more instructions, which might be incorporated into the operating system 2040 and/or other code, such as an application program 2045, contained in the working memory 2035. Such instructions may be read into the working memory 2035 from another computer-readable medium, such as one or more of the storage device(s) 2025. Merely by way of example, execution of the sequences of instructions contained in the working memory 2035 might cause the processor(s) 2010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 2000, various computer-readable media might be involved in providing instructions/code to processor(s) 2010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 2025. Volatile media include, without limitation, dynamic memory, such as the working memory 2035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 2010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 2000.

The communications subsystem 2030 and/or components thereof generally will receive signals, and the bus 2005 then might carry the signals and/or the data, instructions, etc. carried by the signals to the working memory 2035, from which the processor(s) 2010 retrieves and executes the instructions. The instructions received by the working memory 2035 may optionally be stored on a non-transitory storage device 2025 either before or after execution by the processor(s) 2010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A computer-implemented method, comprising:
receiving, at a sensor of a home automation system, characteristic data, wherein the characteristic data indicates one or more observed characteristics of a user of a home security system, wherein the home security system is connected to the home automation system;
analyzing the characteristic data to determine a state of the user;
determining, using the characteristic data, that the user has fallen asleep; and
transmitting a communication to the home security system, wherein the communication includes a command to activate the home security system.

2. The method of claim 1, wherein determining that the user has fallen asleep includes comparing the characteristic data to previous characteristic data, wherein the previous characteristic data indicates that the user had not fallen asleep.

3. The method of claim 1, wherein the one or more of the observed characteristics include a physical position of the user, a heart rate of the user, a breathing rate of the user, or a characteristic of the user's brainwaves.

4. The method of claim 1, wherein determining that the user has fallen asleep is based on movements of the user's head detected by the sensor.

5. The method of claim 1, wherein the sensor is included in a remote control of a television distribution system connected to the home automation system.

6. The method of claim 1, further comprising:
receiving home automation data, wherein the home automation data includes data collected over time by the home automation system, and wherein the home automation data is indicative of actions observed in an environment of the home automation system; and
transmitting the communication to the home security system based on the home automation data.

7. The method of claim 1, wherein determining that the user has fallen asleep is based on detecting that a portion of the user has remained at a particular orientation for a period of time longer than a threshold time.

8. The method of claim 1, wherein determining that the user has fallen asleep includes determining that the user's eyes are closed.

9. The method of claim 1, further comprising:
receiving updated characteristic data, wherein the updated characteristic data indicates one or more observed characteristics of a user of a home security system;
analyzing the updated characteristic data to determine an updated state of the user;
determining, using the updated characteristic data, that the user has woken up; and
transmitting a new communication to the home security system, wherein the communication includes a command to deactivate the home security system.

10. A home automation system, comprising:
a home automation device including a sensor, the sensor configured to receive characteristic data, wherein the characteristic data indicates one or more observed characteristics of a user of a home security system, wherein the home security system is connected to the home automation system;
a controller connected to the home automation device, the controller configured to analyze the characteristic data to determine that the user has fallen asleep, and configured to transmit a communication indicating that the home security system should be turned on; and
a home security device connected to the home automation device and the controller, the home security device configured to receive the communication and, upon receiving the communication, turn on the home security system.

11. The home automation system of claim 10, wherein determining that the user has fallen asleep includes comparing the characteristic data to previous characteristic data, wherein the previous characteristic data indicates that the user had not fallen asleep.

12. The home automation system of claim 10, wherein the one or more of the observed characteristics include a physical position of the user, a heart rate of the user, a breathing rate of the user, or a characteristic of the user's brainwaves.

13. The home automation system of claim 10, wherein determining that the user has fallen asleep is based on movements of the user's head detected by the sensor.

14. The home automation system of claim 10, wherein the controller is further configured to receive home automation data, wherein the home automation data includes data collected over time by the home automation device, and wherein the home automation data is indicative of actions observed in an environment of the home automation device, and transmit a communication to the home security device based on the home automation data.

15. The home automation system of claim 10, wherein determining that the user has fallen asleep is based on detecting that a portion of the user has remained at a particular orientation for a period of time longer than a threshold time.

16. The home automation system of claim 10, wherein determining that the user has fallen asleep includes determining that the user's eyes are closed.

17. The home automation system of claim 10, wherein:
the sensor is further configured to receive updated characteristic data, wherein the updated characteristic data indicates one or more observed characteristics of a user of a home security system; and
the controller is further configured to analyze the updated characteristic data to determine an updated state of the user, determine, using the updated characteristic data, that the user has woken up, and transmit a new communication to the home security system, wherein the communication includes a command to deactivate the home security system.

18. A television receiver, comprising:
one or more processors;
a wireless transceiver communicatively coupled to the one or more processors;
a non-transitory computer readable storage medium communicatively coupled to the one or more processors, wherein the non-transitory computer readable storage medium includes instructions that, when executed by the one or more processors, cause the one or more processors to perform operations including:
receiving, at a sensor of a home automation system, characteristic data, wherein the characteristic data indicates one or more observed characteristics of a user of a home security system, wherein the home security system is connected to the home automation system;
analyzing the characteristic data to determine a state of the user;
determining, using the characteristic data, that the user has fallen asleep; and
transmitting a communication to the home security system, wherein the communication includes a command to activate the home security system.

19. The television receiver of claim 18, wherein determining that the user has fallen asleep includes comparing the characteristic data to previous characteristic data, wherein the previous characteristic data indicates that the user had not fallen asleep.

20. The television receiver of claim 18, wherein determining that the user has fallen asleep is based on detecting that a portion of the user has remained at a particular orientation for a period of time longer than a threshold time.
